(19) United States
(12) Patent Application Publication
(10) Pub. No.: US 2025/0008446 A1
(43) Pub. Date: Jan. 2, 2025

(54) TWO SETS OF UPLINK POWER CONTROL PARAMETERS

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 18/346,231

(22) Filed: Jul. 1, 2023

(51) Int. Cl. H04W 52/14; H04W 72/1268

(52) U.S. Cl. CPC H04W 52/146; H04W 72/1268

(57) ABSTRACT

Methods, systems, and devices for wireless communications are described. The network may configure two sets of power control parameters for a user equipment (UE) so that the UE may use different uplink power control parameters for transmissions in different types of time resources associated with different interference conditions. For example, the network may indicate for a carrier which time resources are uplink time resources and which time resources are subband full-duplex (SBFD) resources, and UE may apply a first set of uplink power control parameters to transmissions in the uplink resources and a second set of uplink power control parameters to transmissions in the SBFD resources. For time division duplexing scenarios, the network may similarly configure two sets of uplink power control parameters for the UE to apply to time resources that the network identifies cause cross-link interference (CLI) and time resources that the network identifies do not cause CLI.

### FIELD OF TECHNOLOGY

The following relates to wireless communications, including two sets of uplink power control parameters.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may implement full-duplex communication according to which network devices may simultaneously transmit and receive. In some deployments, a network entity may employ subband full-duplex (SBFD) according to which the network entity may receive via a first set of one or more subbands (which may be referred to as uplink subbands) and transmit via a second set of one or more subbands (which may be referred to as downlink subbands), where the first and second sets of subbands may be non-overlapping in the frequency domain. Within a carrier, SBFD time resources (e.g., slots or symbols) may be interspersed with uplink time resources (e.g., a time resource where the entire carrier bandwidth is used for uplink) and downlink time resources (e.g., a time resource where the entire carrier bandwidth is used for downlink). For example, uplink time resources may be time division duplexing (TDD) uplink resources. SBFD time resources may be associated with higher cross-link interference (CLI) than TDD uplink time resources. Some network entities may implement dynamic TDD communications. Dynamic TDD time resources may be misaligned with TDD time resources for other cells, which may result in inter-cell CLI. CLI may negatively impact communications performance and/or may result in higher transmission power.

### SUMMARY

The described techniques relate to improved methods, systems, devices, and apparatuses that support two sets of uplink power control parameters. For example, the described techniques provide for configuration of two sets of uplink power control parameters (e.g., two sets of open and/or closed loop parameters) for a user equipment (UE) so that the UE may use different uplink power control parameters for uplink transmissions in different types of time resources associated with different interference (e.g., cross-link interference (CLI)) conditions. For example, a network entity may indicate for a carrier which time resources are uplink time resources (e.g., time division duplexing (TDD) uplink resources) and which time resources are subband full duplex (SBFD) time resources. The UE may apply a first configured set of uplink power control parameters to uplink transmissions scheduled in the uplink time resources and a second set of uplink power control parameters to uplink transmissions scheduled in the SBFD time resources. For dynamic TDD scenarios, the network entity may similarly configure two sets of uplink power control parameters for the UE to apply to time resources that the network identifies cause CLI and time resources that the network identifies do not cause CLI.

A method for wireless communications by a user equipment (UE) is described. The method may include receiving control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, receiving scheduling information for a first uplink transmission in a first time resource of the first subset of time resources and a second uplink transmission in a second time resource of the second subset of time resources, performing the first uplink transmission in accordance with the first set of uplink power control parameters based on the first time resource being included within the first subset of time resources, and performing the second uplink transmission in accordance with the second set of uplink power control parameters based on the second time resource being included within the second subset of time resources.

A UE for wireless communications is described. The UE may include one or more memories storing processor executable code, and one or more processors coupled with the one or more memories. The one or more processors may individually or collectively operable to execute the code to cause the UE to receive control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, receive scheduling information for a first uplink transmission in a first time resource of the first subset of time resources and a second uplink transmission in a second time resource of the second subset of time resources, perform the first uplink transmission in accordance with the first set of uplink power control parameters based on the first time resource being included within the first subset of time resources, and perform the second uplink transmission in accordance with the second set of uplink power control parameters based on the second time resource being included within the second subset of time resources.

Another UE for wireless communications is described. The UE may include means for receiving control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, means for receiving scheduling information for a first uplink transmission in a first time resource of the first subset of time resources and a second uplink transmission in a second time resource of the second subset of time resources, means for performing the first uplink transmission in accordance with the first set of uplink power control parameters based on the first time resource being included within the first subset of time resources, and means for performing the second uplink transmission in accordance with the second set of uplink power control parameters based on the second time resource being included within the second subset of time resources.

A non-transitory computer-readable medium storing code for wireless communications is described. The code may include instructions executable by a processor to receive control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, receive scheduling information for a first uplink transmission in a first time resource of the first subset of time resources and a second uplink transmission in a second time resource of the second subset of time resources, perform the first uplink transmission in accordance with the first set of uplink power control parameters based on the first time resource being included within the first subset of time resources, and perform the second uplink transmission in accordance with the second set of uplink power control parameters based on the second time resource being included within the second subset of time resources.

Some examples of the method, UEs, and non-transitory computer-readable medium described herein may further include operations, features, means, or instructions for receiving a first TPC (TPC) associated with the first uplink transmission that indicates a first uplink power control adjustment value to apply to a first cumulative uplink power control adjustment value stored at the UE, where the first set of uplink power control parameters includes the first cumulative uplink power control adjustment value and receiving a second TPC associated with the second uplink transmission that indicates a second uplink power control adjustment value to apply to a second cumulative uplink power control adjustment value stored at the UE, where the first set of uplink power control parameters includes the first cumulative uplink power control adjustment value.

Some examples of the method, UEs, and non-transitory computer-readable medium described herein may further include operations, features, means, or instructions for transmitting capability information that indicates a capability of the UE to support two uplink power control adjustment accumulators, where reception of the first TPC and the second TPC may be based on the capability information.

In some examples of the method, UEs, and non-transitory computer-readable medium described herein, receiving the indication of the second set of uplink power control parameters may include operations, features, means, or instructions for receiving an indication of a respective offset for one or more parameters of the first set of uplink power control parameters.

In some examples of the method, UEs, and non-transitory computer-readable medium described herein, the first set of uplink power control parameters includes a first P0 value and a first alpha value and the second set of uplink power control parameters includes a second P0 value and a second alpha value.

In some examples of the method, UEs, and non-transitory computer-readable medium described herein, the first set of uplink power control parameters includes a first closed loop power state and the second set of uplink power control parameters includes a second closed loop power state.

In some examples of the method, UEs, and non-transitory computer-readable medium described herein, the first set of uplink power control parameters and the second set of uplink power control parameters may be associated with a same configured P0 value and a same configured first alpha value, the first set of uplink power control parameters includes a first closed loop power state, and the second set of uplink power control parameters includes a second closed loop power state.

Some examples of the method, UEs, and non-transitory computer-readable medium described herein may further include operations, features, means, or instructions for receiving a first TPC associated with the first uplink transmission that indicates a first absolute uplink power control adjustment value, where the first set of uplink power control parameters includes a first set of absolute uplink power control adjustment values and the second set of uplink power control parameters includes a second set of absolute uplink power control adjustment values, and where the first absolute uplink power control adjustment value may be one of the first set of absolute uplink power control adjustment values and receiving a second TPC associated with the second uplink transmission that indicates a second absolute uplink power control adjustment value, where the second absolute uplink power control adjustment value may be one of the second set of absolute uplink power control adjustment values.

Some examples of the method, UEs, and non-transitory computer-readable medium described herein may further include operations, features, means, or instructions for receiving, with the control information, an indication that the first subset of time resources may be uplink type resources and that the second subset of time resources may be SBFD type uplink subband resources, where the first time resource may be an uplink type resource, and where the second time resource may be a SBFD type uplink subband resource.

Some examples of the method, UEs, and non-transitory computer-readable medium described herein may further include operations, features, means, or instructions for receiving, with the control information, an indication that the first subset of time resources may be uplink type TDD resources and that the second subset of time resources may be full duplex type resources, where an uplink bandwidth part of the full duplex type resources at least partially overlaps with a downlink bandwidth part of the full duplex type resources, where the first time resource may be an uplink type TDD resource, and where the second time resource may be a full duplex type resource.

Some examples of the method, UEs, and non-transitory computer-readable medium described herein may further include operations, features, means, or instructions for receiving, with the control information, an indication of TDD resources for a second network entity, where the UE may be associated with a first network entity, where the first subset of time resources may be misaligned with the TDD resources of the second network entity and that the second subset of time resources may be aligned with the TDD resources of the second network entity.

Some examples of the method, UEs, and non-transitory computer-readable medium described herein may further include operations, features, means, or instructions for receiving, with the control information, an indication to apply the first set of uplink power control parameters to the first subset of time resources and to apply the second set of uplink power control parameters to the second subset of time resources.

In some examples of the method. UEs, and non-transitory computer-readable medium described herein, receiving the scheduling information may include operations, features, means, or instructions for receiving a first control message that schedules the first uplink transmission and receiving a second control message that scheduled the second uplink transmission.

In some examples of the method, UEs, and non-transitory computer-readable medium described herein, receiving the scheduling information may include operations, features, means, or instructions for receiving a configured grant that schedules a set of uplink transmissions, the set of uplink transmissions including the first uplink transmission and the second uplink transmission.

A method for wireless communications by a network entity is described. The method may include transmitting, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, transmitting, to the UE, scheduling information for a first uplink transmission in a first time resource of the first subset of time resources and a second uplink transmission in a second time resource of the second subset of time resources, receiving, from the UE, the first uplink transmission in the first time resource, and receiving, from the UE, the second uplink transmission in the second time resource.

A network entity for wireless communications is described. The network entity may include one or more memories storing processor executable code, and one or more processors coupled with the one or more memories. The one or more processors may individually or collectively operable to execute the code to cause the network entity to transmit, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, transmit, to the UE, scheduling information for a first uplink transmission in a first time resource of the first subset of time resources and a second uplink transmission in a second time resource of the second subset of time resources, receive, from the UE, the first uplink transmission in the first time resource, and receive, from the UE, the second uplink transmission in the second time resource.

Another network entity for wireless communications is described. The network entity may include means for transmitting, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, means for transmitting, to the UE, scheduling information for a first uplink transmission in a first time resource of the first subset of time resources and a second uplink transmission in a second time resource of the second subset of time resources, means for receiving, from the UE, the first uplink transmission in the first time resource, and means for receiving, from the UE, the second uplink transmission in the second time resource.

A non-transitory computer-readable medium storing code for wireless communications is described. The code may include instructions executable by a processor to transmit, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources, transmit, to the UE, scheduling information for a first uplink transmission in a first time resource of the first subset of time resources and a second uplink transmission in a second time resource of the second subset of time resources, receive, from the UE, the first uplink transmission in the first time resource, and receive, from the UE, the second uplink transmission in the second time resource.

Some examples of the method, network entities, and non-transitory computer-readable medium described herein may further include operations, features, means, or instructions for transmitting, to the UE, a first TPC associated with the first uplink transmission that indicates a first uplink power control adjustment value to apply to a first cumulative uplink power control adjustment value stored at the UE, where the first set of uplink power control parameters includes the first cumulative uplink power control adjustment value and transmitting, to the UE, a second TPC associated with the second uplink transmission that indicates a second uplink power control adjustment value to apply to a second cumulative uplink power control adjustment value stored at the UE, where the first set of uplink power control parameters includes the first cumulative uplink power control adjustment value.

Some examples of the method, network entities, and non-transitory computer-readable medium described herein may further include operations, features, means, or instructions for receiving, from the UE, capability information that indicates a capability of the UE to support two uplink power control adjustment accumulators, where transmission of the first TPC and the second TPC may be based on the capability information.

In some examples of the method, network entities, and non-transitory computer-readable medium described herein, transmitting the indication of the second set of uplink power control parameters may include operations, features, means, or instructions for transmitting an indication of a respective offset for one or more parameters of the first set of uplink power control parameters.

In some examples of the method, network entities, and non-transitory computer-readable medium described herein, the first set of uplink power control parameters includes a first P0 value and a first alpha value and the second set of uplink power control parameters includes a second P0 value and a second alpha value.

In some examples of the method, network entities, and non-transitory computer-readable medium described herein, the first set of uplink power control parameters includes a first closed loop power state and the second set of uplink power control parameters includes a second closed loop power state.

In some examples of the method, network entities, and non-transitory computer-readable medium described herein, the first set of uplink power control parameters and the second set of uplink power control parameters include a same P0 value and a same first alpha value, the first set of uplink power control parameters includes a first closed loop power state, and the second set of uplink power control parameters includes a second closed loop power state.

Some examples of the method, network entities, and non-transitory computer-readable medium described herein may further include operations, features, means, or instructions for transmitting, to the UE, a first TPC associated with the first uplink transmission that indicates a first absolute uplink power control adjustment value, where the first set of uplink power control parameters includes a first set of absolute uplink power control adjustment values and the second set of uplink power control parameters includes a second set of absolute uplink power control adjustment values, and where the first absolute uplink power control adjustment value may be one of the first set of absolute uplink power control adjustment values and transmitting, to the UE, a second TPC associated with the second uplink transmission that indicates a second absolute uplink power control adjustment value, where the second absolute uplink power control adjustment value may be one of the second set of absolute uplink power control adjustment values.

Some examples of the method, network entities, and non-transitory computer-readable medium described herein may further include operations, features, means, or instructions for transmitting, with the control information, an indication that the first subset of time resources may be uplink type resources and that the second subset of time resources may be SBFD type uplink subband resources.

Some examples of the method, network entities, and non-transitory computer-readable medium described herein may further include operations, features, means, or instructions for transmitting, with the control information, an indication that the first subset of time resources may be uplink type TDD resources and that the second subset of time resources may be full duplex type resources, where an uplink bandwidth part of the full duplex type resources at least partially overlaps with a downlink bandwidth part of the full duplex type resources.

Some examples of the method, network entities, and non-transitory computer-readable medium described herein may further include operations, features, means, or instructions for transmitting, with the control information, an indication to apply the first set of uplink power control parameters to the first subset of time resources and to apply the second subset of uplink power control parameters to the second set of time resources.

Some examples of the method, network entities, and non-transitory computer-readable medium described herein may further include operations, features, means, or instructions for identifying that the first subset of time resources may be misaligned with TDD resources of a second network entity and that the second subset of time resources may be aligned with the TDD resources of the second network entity, where the control information may be based on the identifying.

Some examples of the method, network entities, and non-transitory computer-readable medium described herein may further include operations, features, means, or instructions for transmitting, with the control information, an indication of TDD resources for a second network entity.

In some examples of the method, network entities, and non-transitory computer-readable medium described herein, transmitting the scheduling information may include operations, features, means, or instructions for transmitting a first control message that schedules the first uplink transmission and transmitting a second control message that scheduled the second uplink transmission.

In some examples of the method, network entities, and non-transitory computer-readable medium described herein, transmitting the scheduling information may include operations, features, means, or instructions for transmitting a configured grant that schedules a set of uplink transmissions, the set of uplink transmissions including the first uplink transmission and the second uplink transmission.

### BRIEF DESCRIPTION OF THE DRAWINGS

FIG. 1 shows an example of a wireless communications system that supports two sets of uplink power control parameters in accordance with one or more aspects of the present disclosure.

FIG. 2 shows an example of a resource diagram that supports two sets of uplink power control parameters in accordance with one or more aspects of the present disclosure.

FIG. 3 shows an example of a wireless communications system that supports two sets of uplink power control parameters in accordance with one or more aspects of the present disclosure.

FIG. 4 shows an example of a resource diagram that supports two sets of uplink power control parameters in accordance with one or more aspects of the present disclosure.

FIG. 5 shows an example of a wireless communications system that supports two sets of uplink power control parameters in accordance with one or more aspects of the present disclosure.

FIG. 6 shows an example of a process flow that supports two sets of uplink power control parameters in accordance with one or more aspects of the present disclosure.

FIGS. 7 and 8 show block diagrams of devices that support two sets of uplink power control parameters in accordance with one or more aspects of the present disclosure.

FIG. 9 shows a block diagram of a communications manager that supports two sets of uplink power control parameters in accordance with one or more aspects of the present disclosure.

FIG. 10 shows a diagram of a system including a device that supports two sets of uplink power control parameters in accordance with one or more aspects of the present disclosure.

FIGS. 11 and 12 show block diagrams of devices that support two sets of uplink power control parameters in accordance with one or more aspects of the present disclosure.

FIG. 13 shows a block diagram of a communications manager that supports two sets of uplink power control parameters in accordance with one or more aspects of the present disclosure.

FIG. 14 shows a diagram of a system including a device that supports two sets of uplink power control parameters in accordance with one or more aspects of the present disclosure.

FIGS. 15 and 16 shows flowcharts illustrating methods that support two sets of uplink power control parameters in accordance with one or more aspects of the present disclosure.

### DETAILED DESCRIPTION

A wireless communications system may implement full-duplex communication according to which network devices may simultaneously transmit and receive. In some deployments, a network entity may employ subband full-duplex (SBFD) according to which the network entity may receive via a first set of one or more subbands (which may be referred to as uplink subbands) and transmit via a second set of one or more subbands (which may be referred to as downlink subbands), where the first and second sets of subbands may be non-overlapping in the frequency domain. Within a carrier, SBFD time resources (e.g., slots or symbols) may be interspersed with uplink time resources (e.g., a time resource where the entire carrier bandwidth is used for uplink) and downlink time resources (e.g., a time resource where the entire carrier bandwidth is used for downlink). For example, uplink time resources may be time division duplexing (TDD) uplink resources.

A UE may transmit uplink transmissions to the network entity using a set of open loop and closed loop uplink power control parameters. Open loop parameters may be configured in Radio Resource Control (RRC), and may include a P0 and Alpha value. Closed loop parameters may be more frequently updated by the network entity, for example, in scheduling information for an uplink transmission (e.g., a transmit power command (TPC) field in downlink control information (DCI)). The closed loop parameters indicate an adjustment to the uplink power, and may be either an absolute value or an adjustment value to apply to a cumulative value. For example, the network may configure the UE to maintain an accumulator which accumulates adjustments indicated by multiple TPC commands. The uplink transmit power affects cross-link interference (CLI) experienced by the network entity and other UEs. SBFD time resources may be more susceptible to causing CLI than uplink time resources. For example, an uplink transmission by one UE in the uplink subband of an SBFD time resource may cause CLI at a second UE receiving a downlink transmission in the downlink subband(s) of the same SBFD time resource. Similarly, downlink transmissions in a downlink subband by one network entity may cause CLI for a neighboring network entity receiving an uplink transmission in the uplink subband. Additionally, different network entities may operate in different TDD patterns, meaning that some uplink time resources may cause CLI between UEs while other uplink time resources may not cause CLI between UEs. If only one set of uplink power control parameters is configured for a UE, the UE may not be able to adjust uplink power for different interference conditions caused by SBFD versus uplink time resources. Similarly, if only one set of uplink power control parameters is configured for a UE, the network may not be able to adjust for interference differences in uplink time resources that cause CLI versus uplink time resources that do not cause CLI due to dynamic TDD patterns.

A network entity may configure two sets of uplink power control parameters (e.g., two sets of open and/or closed loop parameters) for a UE so that the UE may use different uplink power control parameters for uplink transmissions in different types of time resources associated with different interference conditions. For example, a network entity may indicate for a carrier which time resources are uplink time resources and which time resources are SBFD time resources. The UE may apply a first configured set of uplink power control parameters to uplink transmissions scheduled in the uplink time resources and a second set of uplink power control parameters to uplink transmissions scheduled in the SBFD time resources. For example, the network may configure two different sets of open loop uplink power control parameters for uplink and SBFD time resources. As another example, the UE may maintain two different accumulators, one for uplink time resources and one for SBFD time resources such that the network may separately dynamically update the uplink power for uplink and SBFD time resources for a UE. As another example, the UE may interpret the absolute adjustment indicated by the TPC field differently based on whether the corresponding uplink transmission is scheduled in an uplink time resource or an SBFD time resource (e.g., the absolute values may be larger for SBFD resources to enable larger power control adjustments). For dynamic TDD scenarios, the network entity may similarly configure two sets of uplink power control parameters for the UE to apply to time resources that the network entity identifies cause CLI and time resources that the network entity identifies do not cause CLI.

Aspects of the disclosure are initially described in the context of wireless communications systems. Aspects of the disclosure are further illustrated by and described with reference to resource diagrams and process flows. Aspects of the disclosure are further illustrated by and described with reference to apparatus diagrams, system diagrams, and flowcharts that relate to two sets of uplink power control parameters.

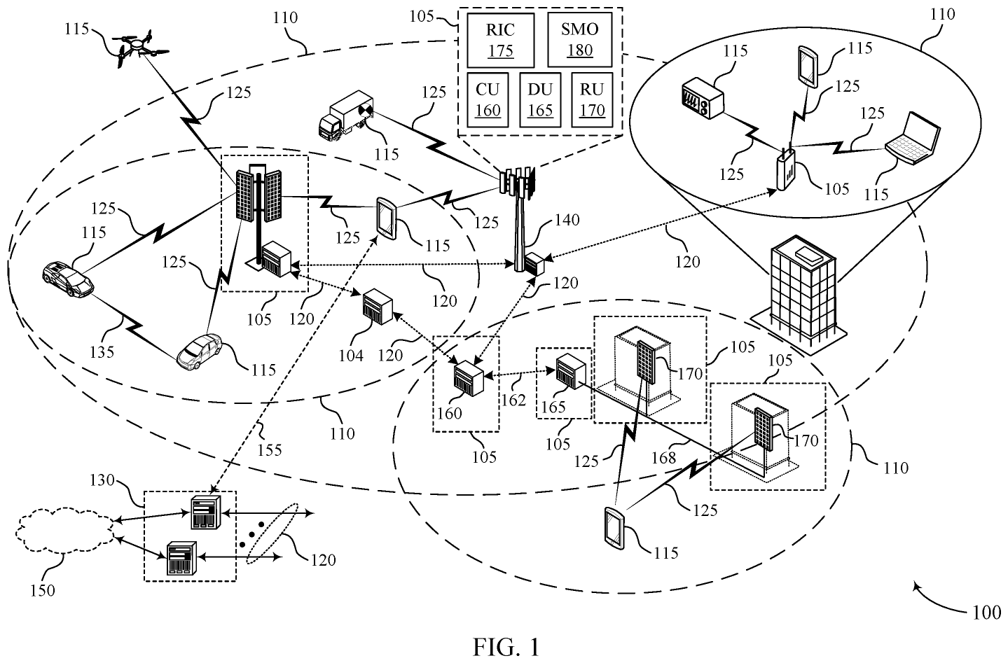

FIG. 1 shows an example of a wireless communications system 100 that supports two sets of uplink power control parameters in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support two sets of uplink power control parameters as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may implement full-duplex communication according to which network devices may simultaneously transmit and receive. In some deployments, a network entity 105 may employ SBFD according to which the network entity 105 may receive via a set of one or more uplink subbands of a carrier and transmit via a set of one or more downlink subbands of the carrier, where the uplink and downlink sets of subbands may be non-overlapping in the frequency domain. Within a carrier, SBFD time resources (e.g., slots or symbols) may be interspersed with uplink time resources (e.g., a time resource where the entire carrier bandwidth is used for uplink) and downlink time resources (e.g., a time resource where the entire carrier bandwidth is used for downlink).

A UE 115 may transmit uplink transmissions to the network entity 105 using a set of open loop and closed loop power control parameters. Open loop parameters may be configured in RRC, and may include a P0 and alpha value. Closed loop parameters may be more frequently updated by the network entity 105, for example, in scheduling information for an uplink transmission (e.g., a TPC field in DCI). The closed loop parameters indicate an adjustment to the uplink power, and may be either an absolute value or a value to apply to a cumulative value. For example, the network may configure the UE 115 to maintain an accumulator which accumulates adjustments indicated by multiple TPC commands. For example, the uplink transmit power for a physical uplink shared channel (PUSCH) transmission in transmission occasion i, may be given by Equation 1, where j is the parameter set configuration index, q_{d} is the reference signal index for the active downlink BWP, I is the PUSCH power control adjustment state index, P_{CMAX,f,c}(i) is the UE 115 configured maximum output power for carrier f. P_{O_PUSCH,b,f,c}(j) is an open loop parameter (e.g., P0), M_{RB,fb,f,c}^{PUSCH}(i) is the bandwidth of the PUSCH resource assignment expressed in the number of resource blocks, PL_{b,f,c}(q_{d}) is a pathloss estimated by the UE 115, α_{b,f,c}(j) is an open loop power parameter (e.g., alpha) between 0 and 1 to compensate for estimated pathloss, Δ_{TF,b,f,c}(i) is a parameter determined based on the modulation and coding scheme, and f_{b,f,c}(i, l) is the closed loop power control adjustment state indicated by the TPC(s).

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} {M}_{RB , fb , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} dBm \qquad ( 1 )$$

The uplink transmit power affects CLI experienced by the network entity 105 and other UEs 115. SBFD time resources may be more susceptible to causing CLI than uplink time resources (e.g., TDD uplink time resources). For example, an uplink transmission by one UE 115 in the uplink subband of an SBFD time resource may cause CLI at a second UE 115 receiving a downlink transmission in the downlink subband(s) of the same SBFD time resource. Similarly, downlink transmissions in a downlink subband by one network entity 105 may cause CLI for a neighboring network entity 105 receiving an uplink transmission in the uplink subband. Additionally, or alternatively, different network entities 105 may operate in different TDD patterns, meaning that some uplink time resources may cause CLI between UEs 115 while other uplink time resources may not cause CLI between UEs 115. If only one set of uplink power control parameters is configured for a UE 115, the UE 115 may not be able to adjust uplink power for different interference conditions caused by SBFD versus uplink time resources. Similarly, if only one set of uplink power control parameters is configured for a UE 115, the network may not be able to adjust for interference differences in uplink time resources that cause CLI versus uplink time resources that do not cause CLI due to dynamic TDD patterns.

A network entity 105 may configure two sets of uplink power control parameters (e.g., two sets of open and/or closed loop parameters) for a UE 115 so that the UE 115 may use different uplink power control parameters for uplink transmissions in different types of time resources associated with different interference conditions. For example, a network entity 105 may indicate for a carrier which time resources are uplink time resources and which time resources are SBFD time resources. The UE 115 may apply a first configured set of uplink power control parameters to uplink transmissions scheduled in the uplink time resources and a second configured set of uplink power control parameters to uplink transmissions scheduled in the SBFD time resources. For example, the network entity 105 may configure two different sets of open loop uplink power control parameters for uplink and SBFD time resources. As another example, the UE 115 may maintain two different accumulators, one for uplink time resources and one for SBFD time resources such that the network may separately dynamically update the uplink power for uplink and SBFD time resources for a UE 115. As another example, the UE 115 may interpret the absolute adjustment indicated by the TPC field differently based on whether the corresponding uplink transmission is scheduled in an uplink time resource or an SBFD time resource (e.g., the absolute values may be larger for SBFD time resources to enable larger power control adjustments). For dynamic TDD scenarios, the network entity 105 may similarly configure two sets of uplink power control parameters for the UE 115 to apply to time resources that the network identifies cause CLI and time resources that the network identifies do not cause CLI.

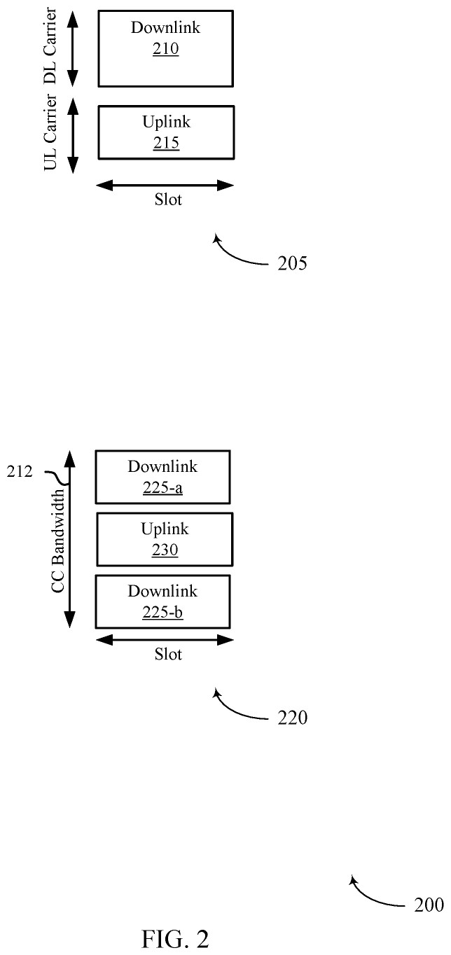

FIG. 2 shows an example of a resource diagram 200 that supports two sets of uplink power control parameters in accordance with one or more aspects of the present disclosure The resource diagram 200 may implement aspects of the wireless communications system 100.

As described herein, some wireless communications systems may implement full duplex communications. Full duplex communications may be in-band full duplex (IBFD) communications or subband full duplex communications (e.g., flexible duplex). For example, a network entity 105 may use full duplex communications for MU-MIMO applications.

A first example 205 illustrates an example full duplex scenario with one downlink carrier 210 and one uplink carrier 215. For example, the first example illustrates a carrier aggregation based full duplex scenario. A second example 220 illustrates an example SBFD slot with a first downlink subband 225-a, a second downlink subband 225-b, and an uplink subband 230 positioned between the first downlink subband 225-a and the second downlink subband 225-b in frequency. The first downlink subband 225-a, the second downlink subband 225-b, and the uplink subband 230 may be within a same single component carrier 212. As shown in the second example 220, the downlink subbands 225 and uplink subband 230 may be separated in frequency by guard bands. Although the uplink subband 230 is shown between downlink subbands 225, the uplink and downlink subbands may be arranged in any order.

Implementation of full duplex communications increases uplink duty cycle, leading to latency reduction. For example, in an SBFD example, it is possible for a UE 115 to transmit an uplink signal in the uplink subband 230 of a legacy downlink slot (if SBFD is configured for the legacy downlink slot) or a flexible slot, or for a UE 115 to receive a downlink transmission in the downlink subband 225 in a legacy uplink slot (if SBFD is configured for the legacy uplink slot), which may reduce latency as the UE 115 may not wait for an uplink slot to transmit an uplink transmission or a downlink slot to receive a downlink transmission. Additionally, or alternatively, implementation of full duplex communications may enhance system capacity, resource utilization, and/or spectrum efficiency. Additionally, or alternatively, implementation of full duplex communications may enable flexible and dynamic uplink and downlink resource adaption according to uplink and downlink traffic conditions.

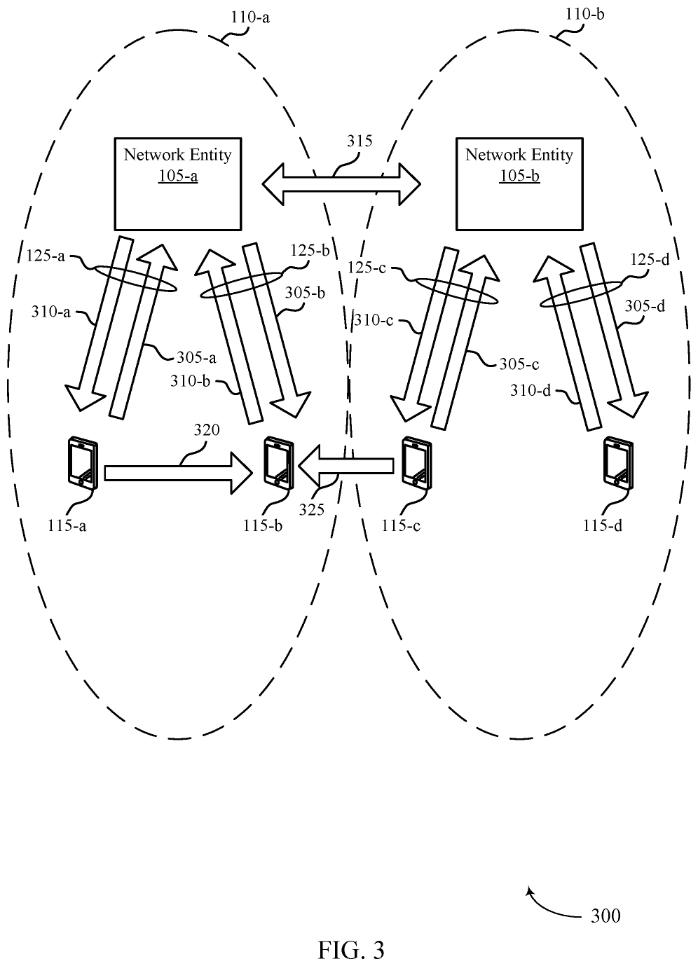

FIG. 3 shows an example of a wireless communications system 300 that supports two sets of uplink power control parameters in accordance with one or more aspects of the present disclosure. The wireless communications system 300 may implement aspects of the wireless communications system 100. For example, the wireless communications system 300 may include a UE 115-a, a UE 115-b, a UE 115-c, and a UE 115-d, which may be examples of a UE 115 as described herein. The wireless communications system 300 may include a network entity 105-a and a network entity 105-b, which may be examples of a network entity 105 as described herein.

The UE 115-a and the UE 115-b may be within a coverage area 110-a served by the network entity 105-a. The UE 115-c and the UE 115-d may be within a coverage area 110-b served by the network entity 105-b. The UE 115-a may communicate with the network entity 105-a using a communication link 125-a, and the UE 115-b may communicate with the network entity 105-a using a communication link 125-b. The UE 115-c may communicate with the network entity 105-b using a communication link 125-c, and the UE 115-d may communicate with the network entity 105-b using a communication link 125-d. The communication link 125-a may be an example of an NR or LTE link between the UE 115-a and the network entity 105-a. The communication link 125-b may be an example of an NR or LTE link between the UE 115-b and the network entity 105-a. The communication link 125-c may be an example of an NR or LTE link between the UE 115-c and the network entity 105-b. The communication link 125-d may be an example of an NR or LTE link between the UE 115-d and the network entity 105-b. The communication link 125-a, the communication link 125-b. the communication link 125-c, and the communication link 125-d may include bi-directional links that enable both uplink and downlink communications. For example, the UE 115-a may transmit uplink signals 305-a (e.g., uplink transmissions), such as uplink control signals or uplink data signals, to the network entity 105-a using the communication link 125-a and the network entity 105-a may transmit downlink signals 310-a (e.g., downlink transmissions), such as downlink control signals or downlink data signals, to the UE 115-a using the communication link 125-a. The UE 115-b may transmit uplink signals 305-b (e.g., uplink transmissions), such as uplink control signals or uplink data signals, to the network entity 105-a using the communication link 125-b and the network entity 105-a may transmit downlink signals 310-b (e.g., downlink transmissions), such as downlink control signals or downlink data signals, to the UE 115-b using the communication link 125-b. The UE 115-c may transmit uplink signals 305-c (e.g., uplink transmissions), such as uplink control signals or uplink data signals, to the network entity 105-b using the communication link 125-c and the network entity 105-b may transmit downlink signals 310-c (e.g., downlink transmissions), such as downlink control signals or downlink data signals, to the UE 115-c using the communication link 125-c. The UE 115-d may transmit uplink signals 305-d (e.g., uplink transmissions), such as uplink control signals or uplink data signals, to the network entity 105-b using the communication link 125-d and the network entity 105-b may transmit downlink signals 310-d (e.g., downlink transmissions), such as downlink control signals or downlink data signals, to the UE 115-d using the communication link 125-d.

The network entity 105-a and/or the network entity 105-b may implement full duplex communications. For example, the network entity 105-a may communicate with the UE 115-a and the UE 115-b using SBFD. For example, the network entity 105-a may receive an uplink signal 305-a from the UE 115-a in an uplink subband of a same time resource that the network entity 105-a transmits a downlink signal 310-b via one or more downlink subbands to the UE 115-b. Similarly, the network entity 105-b may receive an uplink signal 305-c from the UE 115-c in an uplink subband of the same time resource that the network entity 105-b transmits a downlink signal 310-d via one or more downlink subbands to the UE 115-d.

The transmission of the uplink signal 305-a in the same time resource may cause intra-cell inter-subband CLI 320 to the UE 115-b with regard to reception of the downlink signal 310-b in the same time resource. The transmission of the uplink signal 305-c in the same time resource may cause inter-subband inter-cell CLI 325 to the UE 115-b with regard to reception of the downlink signal 310-b in the same time resource. Inter-cell CLI may occur for UEs 115 near the perimeter of the coverage area 110-a (e.g., in close proximity to UEs 115 served by another network entity 105). Downlink signals 310 (e.g., the downlink signal 310-a and the downlink signal 310-b) transmitted by the network entity 105-a may cause inter-cell CLI 315 with regard to reception of the uplink signals 305 (e.g., the uplink signal 305-c and the uplink signal 305-d) at the network entity 105-b, and downlink signals 310 (e.g., the downlink signal 310-c and the downlink signal 310-d) transmitted by the network entity 105-b may cause inter-cell CLI 315 with regard to reception of the uplink signals 305 (e.g., the uplink signal 305-a and the uplink signal 305-b) at the network entity 105-a.

In some examples, the network entity 105-a and/or the network entity 105-b may implement TDD communications. In some examples, the uplink and downlink time resources may be misaligned between the network entity 105-a and the network entity 105-b. For example, some uplink time resources for the UE 115-c and the UE 115-d may overlap with downlink time resources for the UE 115-a and the UE 115-b. Some downlink time resources for the UE 115-a and the UE 115-b may not overlap with uplink time resources for the UE 115-c and the UE 115-d. Misaligned TDD may result in inter-cell CLI 325. For example, an uplink signal 305-a in an uplink time resource that at least partially overlaps with a downlink time resource for the UE 115-b may cause inter-cell CLI 325 for the UE 115-b with respect to reception of a downlink signal 310-b in the downlink time resource. In some examples, the network entity 105-a and the network entity 105-b may communicate TDD schedules (e.g., via a backhaul communication link 120), and accordingly, the network entity 105-b may identify which uplink time resources are likely to cause CLI for the UEs 115 served by the network entity 105-a (e.g., which uplink time resources for the UEs 115 served by the network entity 105-b at least partially overlap with downlink time resources for the UEs 115 served by the network entity 105-a).

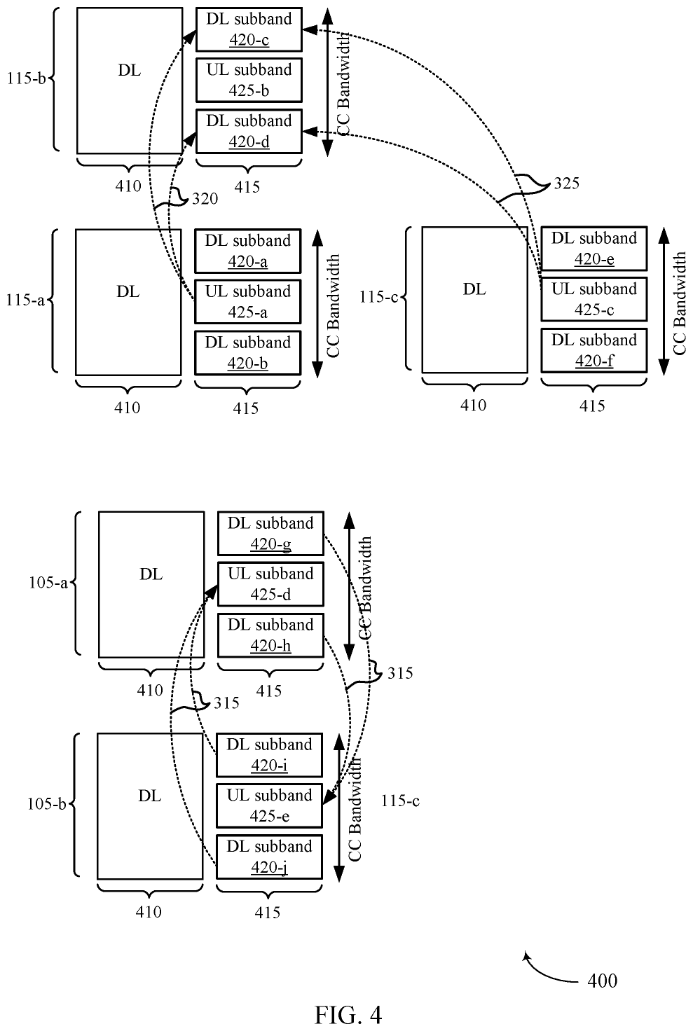

FIG. 4 shows an example of a resource diagram 400 that supports two sets of uplink power control parameters in accordance with one or more aspects of the present disclosure. The resource diagram 400 may implement aspects of the wireless communications system 100 or the wireless communications system 300.

For example, the resource diagram 400 shows communication resources including a downlink slot 410 and an SBFD slot 415 configured for the UE 115-a, the UE 115-b, the UE 115-c, the network entity 105-a, and the network entity 105-b of FIG. 4. As shown, the SBFD slot 415 for the UE 115-a includes a first downlink subband 420-a, an uplink subband 425-a, and a second uplink subband 420-b. The SBFD slot 415 for the UE 115-b includes a first downlink subband 420-c, an uplink subband 425-b, and a second downlink subband 420-d. The SBFD slot 415 for the UE 115-c includes a first downlink subband 420-e, an uplink subband 425-c, and a second uplink subband 420-f. The SBFD slot 415 for the network entity 105-a includes a first downlink subband 420-g, an uplink subband 425-d, and a second downlink subband 420-h. The SBFD slot 415 for the network entity 105-b includes a first downlink subband 420-i, an uplink subband 425-e, and a second downlink subband 420-j.

As described herein, transmissions in the SBFD slot 415 may cause CLI. For example, an uplink transmission by the UE 115-a in the uplink subband 425-b may cause intra-cell inter-subband CLI 320 in the first downlink subband 420-c and/or the second downlink subband 420-d for the UE 115-b. An uplink transmission by the UE 115-c in the uplink subband 425-c may cause inter-subband inter-cell CLI 325 in the first downlink subband 420-c and/or the second downlink subband 420-d for the UE 115-b. A downlink transmission by the network entity 105-a in the first downlink subband 420-g or the second downlink subband 420-h may cause inter network entity (e.g., inter gNB) inter-cell CLI 315 in the uplink subband 425-e for the UE 115-b, and a downlink transmission by the network entity 105-b in the first downlink subband 420-i or the second downlink subband 420-j may cause inter network entity (e.g., inter gNB) inter-cell CLI 315 in the uplink subband 425-d for the UE 115-a.

CLI may negatively affect communications performance, and accordingly CLI mitigation techniques may be applied. As described herein, higher transmission power causes more CLI, and accordingly, the network entities 105 may configure UEs 115 with two sets of uplink power control parameters. One set of uplink power control parameters may be used by a UE 115 in time resources less likely to cause CLI (e.g., legacy TDD uplink time resources or TDD uplink resources that do not overlap with TDD downlink resources of another cell). Another set of uplink power control parameters may be used by a UE 115 in time resources that are more likely to cause CLI (e.g., SBFD time resources or TDD uplink resources that overlap with TDD downlink resources of another cell). Thus, lower uplink transmission power may be used for uplink transmissions in time resources that are more likely to cause CLI, and CLI may therefore be reduced.

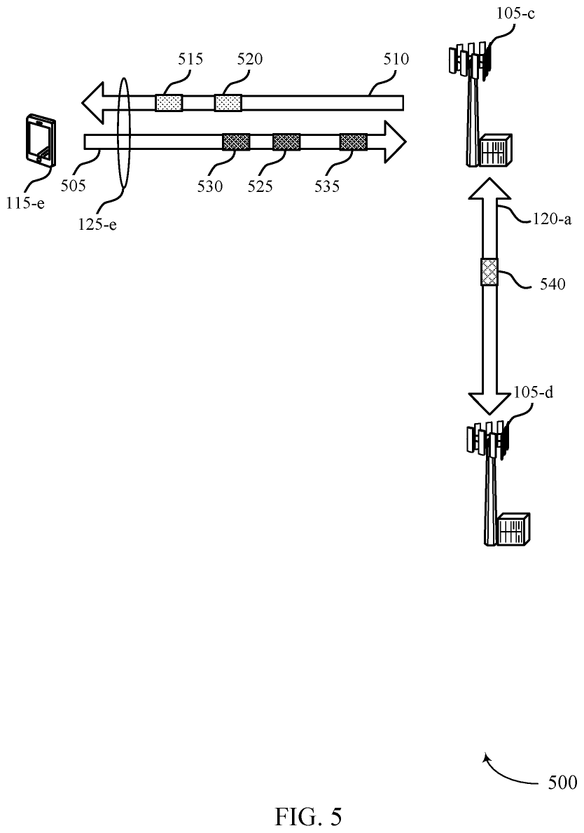

FIG. 5 shows an example of a wireless communications system 500 that supports two sets of uplink power control parameters in accordance with one or more aspects of the present disclosure. The wireless communications system 500 may implement aspects of the wireless communications system 100 or the wireless communications system 300. For example, the wireless communications system 500 may include a UE 115-e, which may be an example of a UE 115 as described herein. The wireless communications system 300 may include a network entity 105-c and a network entity 105-d, which may be examples of a network entity 105 as described herein.

The UE 115-e may communicate with the network entity 105-a using a communication link 125-e. The communication link 125-e may be an example of an NR or LTE link between the UE 115-e and the network entity 105-c. The communication link 125-e may include a bi-directional link that enable both uplink and downlink communications. For example, the UE 115-e may transmit uplink signals 505 (e.g., uplink transmissions), such as uplink control signals or uplink data signals, to the network entity 105-c using the communication link 125-e and the network entity 105-c may transmit downlink signals 510 (e.g., downlink transmissions), such as downlink control signals or downlink data signals, to the UE 115-e using the communication link 125-e. The network entity 105-c may communicate with the network entity 105-d using a backhaul communication link 120-a, which may be an example of a backhaul communication link 120 as described herein.

The network entity 105-c may transmit control signaling 515 to the UE 115-e that configures a first set of uplink power control parameters and a second set of uplink power control parameters. For example, the control signaling 515 may be RRC signaling or an initial access message (e.g., a random access channel (RACH) response message). The two sets of uplink power control parameters may be associated with first and second subsets of time resources. The first subset of time resources may be more likely to cause CLI at other UEs 115 (e.g., SBFD time resources or inter-cell misaligned TDD resources), and the second subset of time resources may be less likely to cause CLI at other UEs 115 (e.g., legacy uplink resources and/or inter-cell aligned legacy uplink resources). The network entity 105-c may transmit scheduling information 520 that schedules a first uplink transmission 525 in a time resource of the first subset of time resources and a second uplink transmission 530 in a time resource of the second subset of time resources. The UE 115-e may transmit the first uplink transmission 525 in accordance with the first set of uplink power control parameters based on the first uplink transmission 525 being scheduled in a time resource of the first subset of time resources. The UE 115-e may transmit the second uplink transmission 530 in accordance with the second set of uplink power control parameters based on the second uplink transmission 530 being scheduled in a time resource of the second subset of time resources.

In some examples, the UE 115-e may be an SBFD aware UE, and the control signaling 515 may semi-statically configure the two sets of uplink power control parameters for SBFD and non-SBFD time resources (e.g., the first subset of time resources are SBFD time resources and the second subset of time resources are non-SBFD time resources (e.g., legacy uplink time resources)).

In some examples, the two sets of uplink power control parameters may include two different sets of open loop power control parameters (e.g., P0 and alpha).

In some examples, the two sets of uplink power control parameters may include two closed loop indices and/or power states. For example, the UE 115-e may maintain two accumulators, one for the power state of SBFD time resources and one for the power state of non-SBFD time resources. For example, the UE 115-e may be RRC configured with the RRC parameter tpc-Accumulation enabled. The network entity 105-c may transmit TPCs to the UE 115-e that indicated closed loop adjustments to the uplink power control state. When tpc-Accumulation is enabled, the UE 115-e may accumulate TPCs to determine or identify a total closed loop adjustment value. When tpc-Accumulation is not enabled, the TPC may indicate an absolute power adjustment value. For example, the TPC may be indicated in a 2 bit field, and accordingly 4 TPC adjustment values may be possible. As another example, the TPC may be indicated in a 3 bit field, and accordingly 8 TPC adjustment values may be possible. In some examples, TPCs may be transmitted in scheduling information 520. For example, the scheduling information 520 may include a first DCI that schedules the first uplink transmission 525 and a second DCI that schedules the second uplink transmission 530. The first DCI may include a TPC for the first uplink transmission 525 and the second DCI may include a TPC for the second uplink transmission 530.

The UE 115-a may subsequently accumulate TPCs in the respective accumulators based on whether the TPC commands are for uplink transmissions (e.g., PUSCH transmissions, physical uplink control channel (PUCCH) transmissions, or sounding reference signal (SRS) transmissions) in SBFD or non-SBFD time resources. In some examples, the UE 115-c may transmit capability information 535 to the network entity 105-c that indicates the UE 115-e is capable of maintaining two accumulators (e.g., two accumulated deltas for uplink transmissions in different types of uplink resources). For example, the capability information 535 may be transmitted in RRC signaling or during an initial access procedure. The network entity 105-c may transmit the control signaling 515 in response to the capability information. The network entity 105-c may track the transmitted TPC commands and whether each TPC command is accumulated in the first or second accumulator. Accordingly, the network entity 105-c may track the two current closed loop power states for the UE 115-e in order to determine subsequent TPCs.

In some examples, the network entity 105-c may configure a single set of open loop power control parameters (e.g., P0 and alpha) for SFBD and non-SBFD time resources. In such examples, the UE 115-c may implicitly split TPC commands into two accumulators based on whether the TPC commands are for uplink transmissions in SBFD or non-SBFD time resources. In such examples, UE 115-e may transmit capability information 535 to the network entity 105-c that indicates the UE 115-e is capable of maintaining two accumulators, and the network entity 105-c may track the transmitted TPC commands and whether each TPC command is accumulated in the first or second accumulator. Use of the same open loop power control parameters for SFBD and non-SBFD time resources may result in slower power control adjustments and/or higher TPC overhead as compared to use of separate open loop power control parameters.

In some examples, as described herein, where tpc-Accumulation is not enabled, TPCs may indicate absolute closed loop power control adjustment values. In some examples, the control signaling 515 may indicate two sets of absolute TPC adjustment values depending on whether the TPC is for an uplink transmission in an SBFD time resource or a non-SBFD time resource. For example, for a 3 bit TPC, Table 1 shows possible configured values for a first set of absolute adjustments associated with SBFD time resources and Table 2 shows a second set of possible configured values for a second set of absolute adjustments associated with non-SBFD time resources.

TABLE 1

| TPC Command Field Value | Corresponding Adjustment Value (dB) |
|---|---|
| 0 | −10 |
| 1 | −8 |
| 2 | −6 |
| 3 | −4 |
| 4 | −2 |
| 5 | 0 |
| 6 | 2 |
| 7 | 4 |

TABLE 2

| TPC Command Field Value | Corresponding Adjustment Value (dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

In some examples, the control signaling 515 may indicate a first set of uplink power control parameters (e.g., for non-SBFD time resources) and one or more sets of offset values to apply to the uplink power control parameters for uplink transmissions in SBFD time resources. For example, the control signaling may indicate an offset for open loop parameters (e.g., P0 or alpha). For example, the offset may be 6 dB higher for P0 for SBFD symbols. In some examples, the offset(s) may be for closed loop parameters. For example, the control signaling may indicate an offset for absolute TPC adjustment values for SBFD symbols. For example, the offset may be 2 dB for the absolute adjustment value for each TPC command field value for SBFD time resources as compared to non-SBFD time resources.

In some examples, the control signaling 515 may configure a semi-static pattern for the two sets of uplink power control parameters (or the offset value(s)) that corresponds to which time resources are SBFD time resources and which time resources are non-SBFD time resources. In some examples, the scheduling information 520 may indicate whether the UE 115-e should apply the first or second set of uplink power control parameters for the scheduled uplink transmissions. For example, the scheduling information 520 may indicate for the UE 115-e to apply the first set of uplink power control parameters to the first uplink transmission 525 and the second set of uplink power control parameters to the second uplink transmission 530. In some examples, the network entity 105-c may indicate (e.g., in the control signaling 515) which time resources are SBFD time resources and which time resources are non-SBFD time resources, and the UE 115-e may implicitly apply the two sets of uplink power control parameters based on whether an uplink transmission is scheduled in an SBFD time resource or a non-SBFD time resource.

In some examples, instead of SBFD time resources, the first subset of time resources may be FDD resources where the uplink BWP overlaps with the downlink BWP. FDD time resources may alternate or be interspersed with TDD time resources. The FDD time resources where the uplink BWP overlaps with the downlink BWP may cause CLI similarly to SBFD time resources, and accordingly, the same techniques to configure and apply two sets of uplink power control parameters based on whether an uplink transmission is scheduled in an SBFD or non-SBFD (e.g., legacy TDD uplink time resource) may be applied based on whether an uplink transmission is scheduled in an FDD time resource or a non-FDD time resource (e.g., a legacy TDD uplink time resource). For example, the control signaling 515 may configure a semi-static pattern for the two sets of uplink power control parameters (or the offset value(s)) that corresponds to which time resources are FDD time resources and which time resources are non-FDD time resources. As another example, the scheduling information 520 may indicate whether the UE 115-e should apply the first or second set of uplink power control parameters for the scheduled uplink transmissions. As another example, the network entity 105-c may indicate (e.g., in the control signaling 515) which time resources are FDD time resources and which time resources are non-FDD time resources, and the UE 115-e may implicitly apply the two sets of uplink power control parameters based on whether an uplink transmission is scheduled in an FDD time resource or a non-FDD time resource.

As described herein, network entities 105 may implement dynamic TDD. For example, the network entity 105-c may implement dynamic TDD with the UE 115-e and the network entity 105-d may implement dynamic TDD with other UEs 115 served by the network entity 105-d. The network entity 105-d may transmit a control message 540 that indicates the dynamic TDD pattern used by the network entity 105-d to the network entity 105-c. For example, the network entities 105 may exchange TDD common slot formats on F1AP or Xn signaling. Accordingly, the network entity 105-c may identify which TDD time resources are likely to cause CLI for UEs 115 served by the network entity 105-d. For example, the network entity 105-c may identify uplink time resources that overlap with (e.g., are misaligned) downlink time resources for the network entity 105-d and uplink time resources that do not overlap (e.g., are aligned) with downlink time resources for the network entity 105-d. Accordingly, the network entity 105-c may configure a semi-static pattern in control signaling 515 for the UE 115-e for two sets of uplink power control parameters corresponding to TDD uplink resources that cause CLI (misaligned) and TDD uplink resources that do not cause CLI (aligned), similarly to SBFD and non-SBFD time resources.

In some examples, the network entity 105-c may indicate to the UE 115-c, for example, in the control signaling 515, a TDD pattern or slot format used by the network entity 105-d. The UE 115-e may compare the TDD pattern used by the network entity 105-d to the TDD pattern configured by the network entity 105-c for the UE 115-e to identify which TDD time resources for the UE 115-e are misaligned with the TDD resources for the network entity 105-d and which TDD time resources for the UE 115-e are aligned with the TDD resources for the network entity 105-d. Accordingly, the UE 115-c may apply the first set of uplink power control parameters to TDD time resources that are misaligned with the TDD resources for the network entity 105-d (and therefore more likely to cause CLI to UEs 115 communicating with the network entity 105-d) and the UE 115-e may apply the second set of uplink power control parameters to TDD time resources that are aligned with the TDD resources for the network entity 105-d (and therefore less likely to cause CLI to UEs 115 communicating with the network entity 105-d).

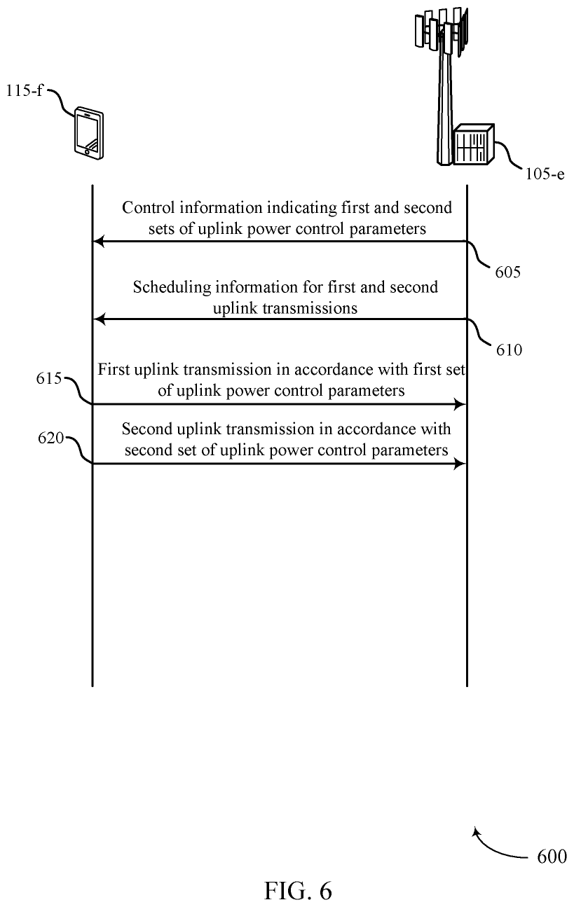

FIG. 6 shows an example of a process flow 600 that supports two sets of uplink power control parameters in accordance with one or more aspects of the present disclosure. The process flow 600 may include a UE 115-f, which may be an example of a UE 115 as described herein. The process flow 600 may include a network entity 105-e, which may be an example of a network entity 105 as described herein. In the following description of the process flow 600, the operations between the network entity 105-e and the UE 115-f may be transmitted in a different order than the example order shown, or the operations performed by the network entity 105-e and the UE 115-f may be performed in different orders or at different times. Some operations may also be omitted from the process flow 600, and other operations may be added to the process flow 600.

At 605, the network entity 105-e may transmit, for example, via a transceiver of the network entity 105-e, control information that indicates a first set of uplink power control parameters and a second set of uplink power control parameters for a carrier. The UE 115-f may receive the control information, for example, via a transceiver of the UE 115-f. In some examples, the control information may be transmitted via RRC signaling or in an initial access message (e.g., a RACH message). The control information may indicate that the first set of uplink power control parameters are associated with a first subset of time resources of a set of time resources of the carrier and the second set of uplink power control parameters are associated with a second subset of time resources of the set of time resources of the carrier. For example, the first subset of time resources may be SBFD time resources and the second subset of time resources may be non-SBFD time resources (e.g., TDD uplink resources). As another example, the first subset of time resources may be FDD time resources where the uplink BWP overlaps in frequency with the downlink BWP, and the second subset of time resources may be non-FDD time resources (e.g., TDD uplink resources). As another example, the first subset of time resources may be uplink TDD time resources that overlap in time and frequency with downlink TDD time resources of another cell, and the second subset of time resources may be TDD time resources that do not overlap in time and frequency with downlink TDD time resources of another cell. For example, another cell may indicate the TDD pattern used by the other cell, and the network entity 105-e may identify which uplink TDD time resources overlap with downlink TDD time resources of the other cell and which uplink TDD time resources do not overlap with the downlink TDD time resources of the other cell.

At 610, the network entity 105-e may transmit, for example, via the transceiver of the network entity 105-e, scheduling information that schedules a first uplink transmission in a first time resource of the first subset of time resources and a second uplink transmission in a second time resource of the second subset of time resources. The UE 115-f may receive the scheduling information, for example, via a transceiver of the UE 115-f. In some examples, the scheduling information may be a configured grant that schedules a set of uplink transmissions including the first and second uplink transmissions. In some examples, the scheduling information may be a first DCI that schedules the first uplink transmission and a second DCI that schedules the second uplink transmission.

At 615, the UE 115-f may transmit the first uplink transmission in accordance with the first set of uplink power control parameters based on the first time resource being included within the first subset of time resources. The UE 115-f may transmit the first uplink transmission using the transceiver of the UE 115-f. The network entity 105-e may receive the first uplink transmission using the transceiver of the network entity 105-e.

At 620, the UE 115-f may transmit the second uplink transmission in accordance with the second set of uplink power control parameters based on the second time resource being included within the second subset of time resources. The UE 115-f may transmit the second uplink transmission using the transceiver of the UE 115-f. The network entity 105-e may receive the second uplink transmission using the transceiver of the network entity 105-e.

As described herein, in some examples, the control information at 605 and/or the scheduling information at 610 may explicitly indicate for the UE 115-f to apply the first set of uplink power control parameters to the first uplink transmission and the second set of uplink power control parameters to the second uplink transmission. For example, the control information may indicate a semi-static pattern of time resources in which the UE 115-f should apply the first set of uplink power control parameters and the second set of uplink power control parameters. In some examples, the control information may indicate which time resources are SBFD time resources and which time resources are non-SBFD time resources (e.g., uplink resources), the UE 115-f may determine to apply the first set of uplink power control parameters to the first uplink transmission based on the first uplink transmission being scheduled in an SBFD time resource, and the UE 115-f may determine to apply the second set of uplink power control parameters to the second uplink transmission based on the second uplink transmission being scheduled in a non-SBFD (e.g., uplink) time resource. In some examples, the control information may indicate which time resources are FDD time resources and which time resources are non-FDD time resources (e.g., uplink resources), the UE 115-f may determine to apply the first set of uplink power control parameters to the first uplink transmission based on the first uplink transmission being scheduled in an FDD time resource, and the UE 115-f may determine to apply the second set of uplink power control parameters to the second uplink transmission based on the second uplink transmission being scheduled in a non-FDD (e.g., uplink) time resource.

In some examples, the network entity 105-e may receive an indication from a second network entity 105 of a TDD pattern (e.g., TDD resources) of the second (e.g., neighboring) network entity 105. In some examples, the network entity 105-e may identify that the first subset of time resources are misaligned with the TDD resources of a second network entity and that the second subset of time resources are aligned with the TDD resources of the second network entity 105. The network entity 105-a may indicate in the control information at 605 a semi-static pattern of time resources in which the UE 115-f should apply the first set of uplink power control parameters and the second set of uplink power control parameters based on whether the time resources are aligned or misaligned with the TDD resources of the second network entity 105. In some examples, the network entity 105-e may indicate, to the UE 115-f in the control information, the TDD resources of the second network entity 105. The UE 115-f may identify, based on the TDD resources of the second network entity 105, that the first uplink transmission is scheduled in a TDD resources that is misaligned with the TDD resources of the second network entity 105, and accordingly the UE 115-f may apply the first set of uplink power control parameters to the first uplink transmission. The UE 115-f may identify, based on the TDD resources of the second network entity 105, that the second uplink transmission is scheduled in a TDD resources that is aligned with the TDD resources of the second network entity 105, and accordingly the UE 115-f may apply the second set of uplink power control parameters to the second uplink transmission.

In some examples, the first set of uplink power control parameters may include a first set of open loop parameters (e.g., P0 and alpha) and a first closed loop power state (e.g., a first accumulator or a first set of absolute adjustment values), and the second set of uplink power control parameters may include a second set of open loop parameters (e.g., P0 and alpha) and a second closed loop power state (e.g., a second accumulator or a second set of absolute adjustment values).

In some examples, the first set of uplink power control parameters and the second set of uplink power control parameters include a same set of open loop power control parameters (e.g., a same P0 value and a same first alpha value), the first set of uplink power control parameters includes a first closed loop power state (e.g., a first accumulator or a first set of absolute adjustment values), and the second set of uplink power control parameters includes a second closed loop power state (e.g., a second accumulator or a second set of absolute adjustment values).

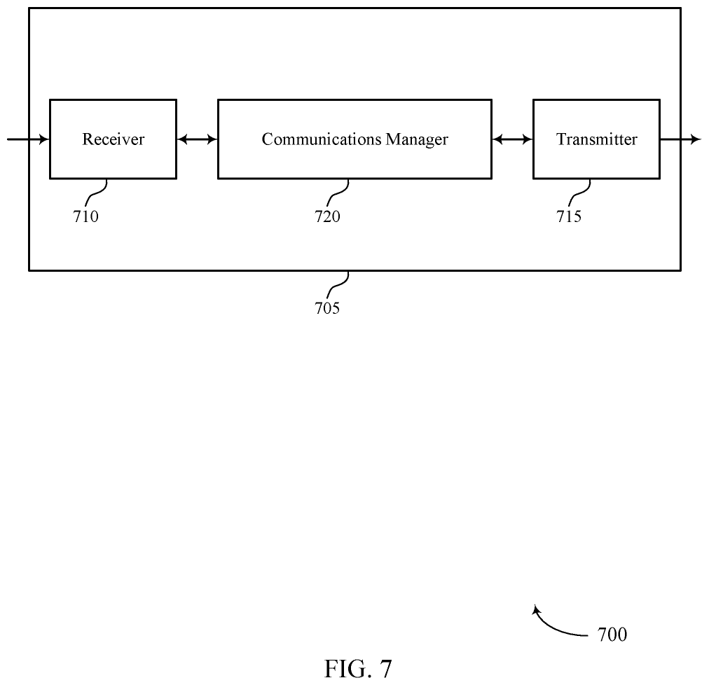

FIG. 7 shows a block diagram 700 of a device 705 that supports two sets of uplink power control parameters in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to two sets of uplink power control parameters). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to two sets of uplink power control parameters). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of two sets of uplink power control parameters as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The communications manager 720 is capable of, configured to, or operable to support a means for receiving scheduling information for a first uplink transmission in a first time resource of the first subset of time resources and a second uplink transmission in a second time resource of the second subset of time resources. The communications manager 720 is capable of, configured to, or operable to support a means for performing the first uplink transmission in accordance with the first set of uplink power control parameters based on the first time resource being included within the first subset of time resources. The communications manager 720 is capable of, configured to, or operable to support a means for performing the second uplink transmission in accordance with the second set of uplink power control parameters based on the second time resource being included within the second subset of time resources.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

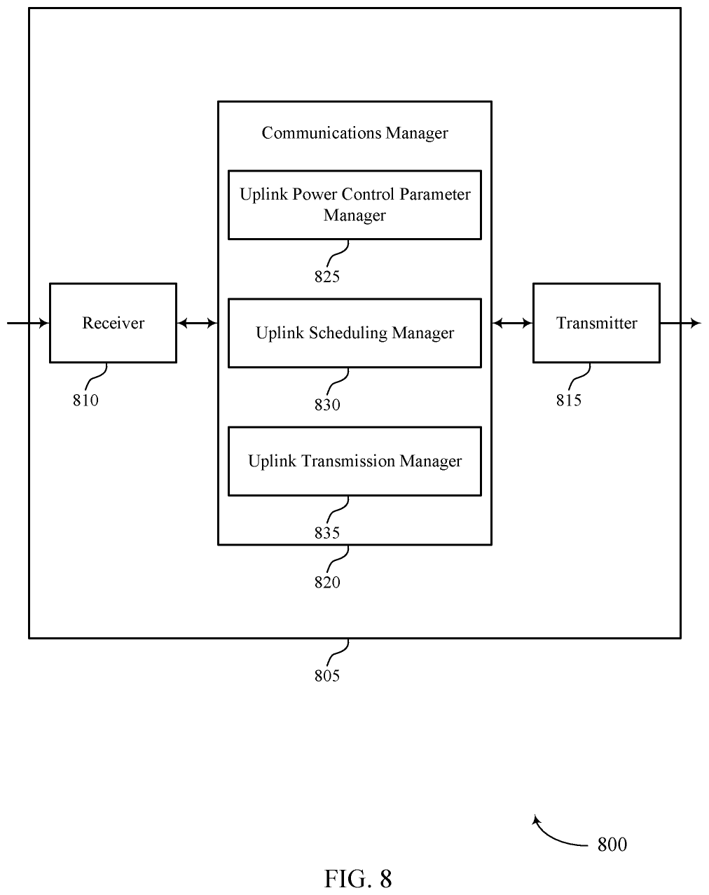

FIG. 8 shows a block diagram 800 of a device 805 that supports two sets of uplink power control parameters in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to two sets of uplink power control parameters). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to two sets of uplink power control parameters). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of two sets of uplink power control parameters as described herein. For example, the communications manager 820 may include an uplink power control parameter manager 825, an uplink scheduling manager 830, an uplink transmission manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The uplink power control parameter manager 825 is capable of, configured to, or operable to support a means for receiving control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The uplink scheduling manager 830 is capable of, configured to, or operable to support a means for receiving scheduling information for a first uplink transmission in a first time resource of the first subset of time resources and a second uplink transmission in a second time resource of the second subset of time resources. The uplink transmission manager 835 is capable of, configured to, or operable to support a means for performing the first uplink transmission in accordance with the first set of uplink power control parameters based on the first time resource being included within the first subset of time resources. The uplink transmission manager 835 is capable of, configured to, or operable to support a means for performing the second uplink transmission in accordance with the second set of uplink power control parameters based on the second time resource being included within the second subset of time resources.

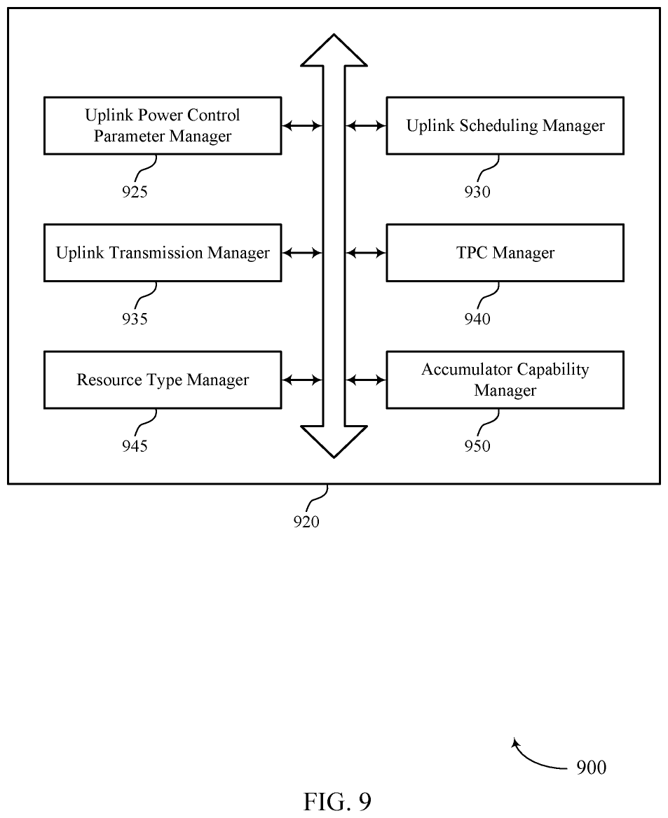

FIG. 9 shows a block diagram 900 of a communications manager 920 that supports two sets of uplink power control parameters in accordance with one or more aspects of the present disclosure. The communications manager 920 may be an example of aspects of a communications manager 720, a communications manager 820, or both, as described herein. The communications manager 920, or various components thereof, may be an example of means for performing various aspects of two sets of uplink power control parameters as described herein. For example, the communications manager 920 may include an uplink power control parameter manager 925, an uplink scheduling manager 930, an uplink transmission manager 935, a TPC manager 940, a resource type manager 945, an accumulator capability manager 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The uplink power control parameter manager 925 is capable of, configured to, or operable to support a means for receiving control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The uplink scheduling manager 930 is capable of, configured to, or operable to support a means for receiving scheduling information for a first uplink transmission in a first time resource of the first subset of time resources and a second uplink transmission in a second time resource of the second subset of time resources. The uplink transmission manager 935 is capable of, configured to, or operable to support a means for performing the first uplink transmission in accordance with the first set of uplink power control parameters based on the first time resource being included within the first subset of time resources. In some examples, the uplink transmission manager 935 is capable of, configured to, or operable to support a means for performing the second uplink transmission in accordance with the second set of uplink power control parameters based on the second time resource being included within the second subset of time resources.

In some examples, the TPC manager 940 is capable of, configured to, or operable to support a means for receiving a first TPC associated with the first uplink transmission that indicates a first uplink power control adjustment value to apply to a first cumulative uplink power control adjustment value stored at the UE, where the first set of uplink power control parameters includes the first cumulative uplink power control adjustment value. In some examples, the TPC manager 940 is capable of, configured to, or operable to support a means for receiving a second TPC associated with the second uplink transmission that indicates a second uplink power control adjustment value to apply to a second cumulative uplink power control adjustment value stored at the UE, where the first set of uplink power control parameters includes the first cumulative uplink power control adjustment value.

In some examples, the accumulator capability manager 950 is capable of, configured to, or operable to support a means for transmitting capability information that indicates a capability of the UE to support two uplink power control adjustment accumulators, where reception of the first TPC and the second TPC is based on the capability information.

In some examples, to support receiving the indication of the second set of uplink power control parameters, the uplink power control parameter manager 925 is capable of, configured to, or operable to support a means for receiving an indication of a respective offset for one or more parameters of the first set of uplink power control parameters.

In some examples, the first set of uplink power control parameters includes a first P0 value and a first alpha value. In some examples, the second set of uplink power control parameters includes a second P0 value and a second alpha value.

In some examples, the first set of uplink power control parameters and the second set of uplink power control parameters are associated with a same configured P0 value and a same configured first alpha value, the first set of uplink power control parameters includes a first closed loop power state, and the second set of uplink power control parameters includes a second closed loop power state. In some examples, the first set of uplink power control parameters includes a first closed loop power state and the second set of uplink power control parameters includes a second closed loop power state.

In some examples, the TPC manager 940 is capable of, configured to, or operable to support a means for receiving a first TPC associated with the first uplink transmission that indicates a first absolute uplink power control adjustment value, where the first set of uplink power control parameters includes a first set of absolute uplink power control adjustment values and the second set of uplink power control parameters includes a second set of absolute uplink power control adjustment values, and where the first absolute uplink power control adjustment value is one of the first set of absolute uplink power control adjustment values. In some examples, the TPC manager 940 is capable of, configured to, or operable to support a means for receiving a second TPC associated with the second uplink transmission that indicates a second absolute uplink power control adjustment value, where the second absolute uplink power control adjustment value is one of the second set of absolute uplink power control adjustment values.

In some examples, the resource type manager 945 is capable of, configured to, or operable to support a means for receiving, with the control information, an indication that the first subset of time resources are uplink type resources and that the second subset of time resources are SBFD type uplink subband resources, where the first time resource is an uplink type resource, and where the second time resource is a SBFD type uplink subband resource.

In some examples, the resource type manager 945 is capable of, configured to, or operable to support a means for receiving, with the control information, an indication that the first subset of time resources are uplink type TDD resources and that the second subset of time resources are full duplex type resources, where an uplink bandwidth part of the full duplex type resources at least partially overlaps with a downlink bandwidth part of the full duplex type resources, where the first time resource is an uplink type TDD resource, and where the second time resource is a full duplex type resource.

In some examples, the uplink power control parameter manager 925 is capable of, configured to, or operable to support a means for receiving, with the control information, an indication to apply the first set of uplink power control parameters to the first subset of time resources and to apply the second set of uplink power control parameters to the second subset of time resources.

In some examples, the resource type manager 945 is capable of, configured to, or operable to support a means for receiving, with the control information, an indication of TDD resources for a second network entity, where the UE is associated with a first network entity, where the first subset of time resources are misaligned with the TDD resources of the second network entity and the second set of time resources are aligned with the TDD resources of the second network entity.

In some examples, to support receiving the scheduling information, the uplink scheduling manager 930 is capable of, configured to, or operable to support a means for receiving a first control message that schedules the first uplink transmission. In some examples, to support receiving the scheduling information, the uplink scheduling manager 930 is capable of, configured to, or operable to support a means for receiving a second control message that scheduled the second uplink transmission.

In some examples, to support receiving the scheduling information, the uplink scheduling manager 930 is capable of, configured to, or operable to support a means for receiving a configured grant that schedules a set of uplink transmissions, the set of uplink transmissions including the first uplink transmission and the second uplink transmission.

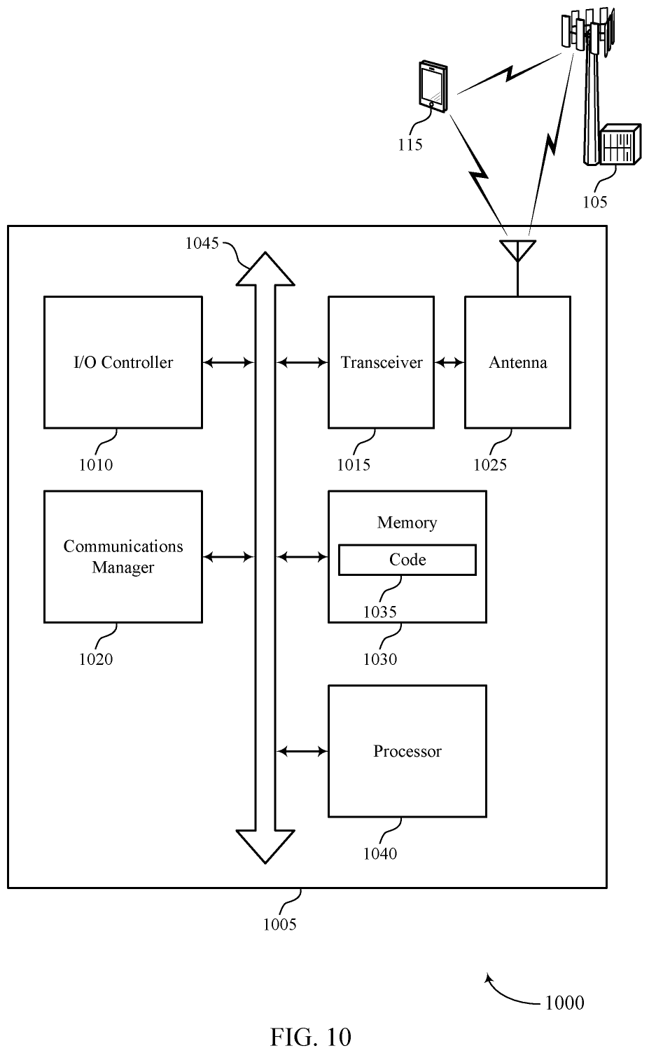

FIG. 10 shows a diagram of a system 1000 including a device 1005 that supports two sets of uplink power control parameters in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting two sets of uplink power control parameters). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communications in accordance with examples as disclosed herein. For example, the communications manager 1020 is capable of, configured to, or operable to support a means for receiving control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The communications manager 1020 is capable of, configured to, or operable to support a means for receiving scheduling information for a first uplink transmission in a first time resource of the first subset of time resources and a second uplink transmission in a second time resource of the second subset of time resources. The communications manager 1020 is capable of, configured to, or operable to support a means for performing the first uplink transmission in accordance with the first set of uplink power control parameters based on the first time resource being included within the first subset of time resources. The communications manager 1020 is capable of, configured to, or operable to support a means for performing the second uplink transmission in accordance with the second set of uplink power control parameters based on the second time resource being included within the second subset of time resources.

By including or configuring the communications manager 1020 in accordance with examples as described herein, the device 1005 may support techniques for improved communication reliability, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of two sets of uplink power control parameters as described herein, or the at least one processor 1040 and the at least one memory 1030 may be otherwise configured to, individually or collectively, perform or support such operations.

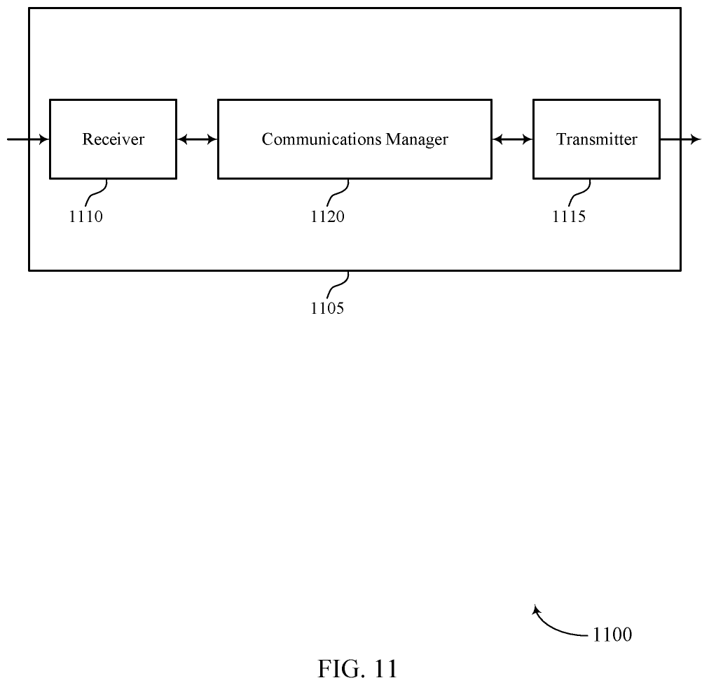

FIG. 11 shows a block diagram 1100 of a device 1105 that supports two sets of uplink power control parameters in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of two sets of uplink power control parameters as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The communications manager 1120 is capable of, configured to, or operable to support a means for transmitting, to the UE, scheduling information for a first uplink transmission in a first time resource of the first subset of time resources and a second uplink transmission in a second time resource of the second subset of time resources. The communications manager 1120 is capable of, configured to, or operable to support a means for receiving, from the UE, the first uplink transmission in the first time resource. The communications manager 1120 is capable of, configured to, or operable to support a means for receiving, from the UE, the second uplink transmission in the second time resource.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

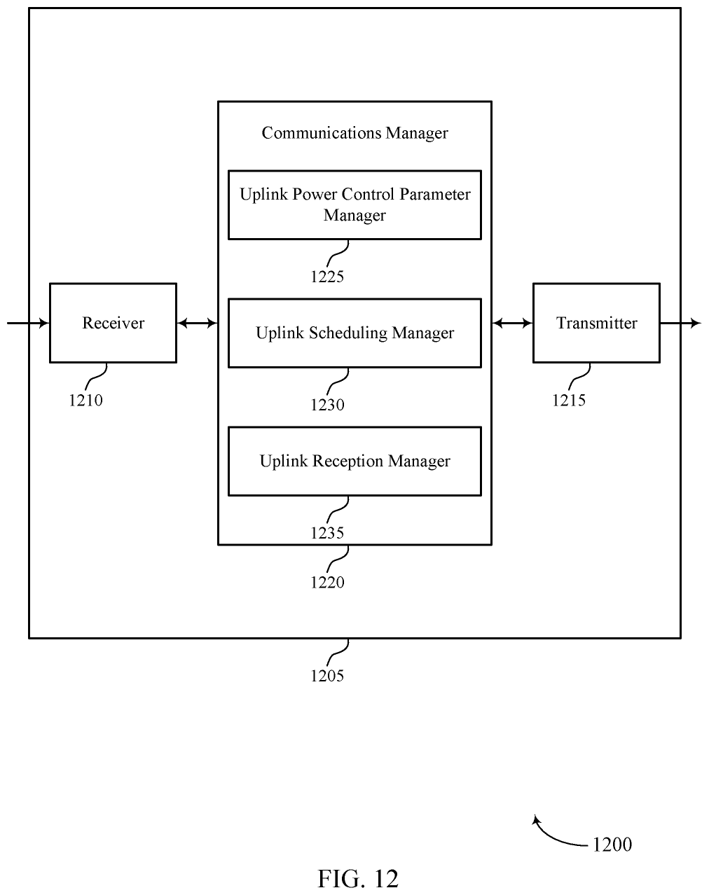

FIG. 12 shows a block diagram 1200 of a device 1205 that supports two sets of uplink power control parameters in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of two sets of uplink power control parameters as described herein. For example, the communications manager 1220 may include an uplink power control parameter manager 1225, an uplink scheduling manager 1230, an uplink reception manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The uplink power control parameter manager 1225 is capable of, configured to, or operable to support a means for transmitting, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The uplink scheduling manager 1230 is capable of, configured to, or operable to support a means for transmitting, to the UE, scheduling information for a first uplink transmission in a first time resource of the first subset of time resources and a second uplink transmission in a second time resource of the second subset of time resources. The uplink reception manager 1235 is capable of, configured to, or operable to support a means for receiving, from the UE, the first uplink transmission in the first time resource. The uplink reception manager 1235 is capable of, configured to, or operable to support a means for receiving, from the UE, the second uplink transmission in the second time resource.

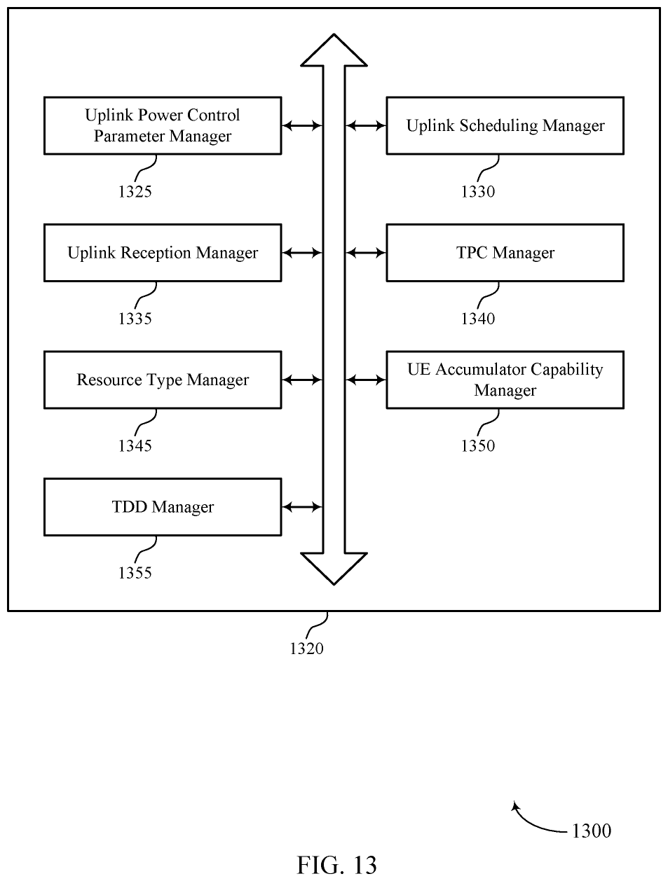

FIG. 13 shows a block diagram 1300 of a communications manager 1320 that supports two sets of uplink power control parameters in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of two sets of uplink power control parameters as described herein. For example, the communications manager 1320 may include an uplink power control parameter manager 1325, an uplink scheduling manager 1330, an uplink reception manager 1335, a TPC manager 1340, a resource type manager 1345, a UE accumulator capability manager 1350, a TDD manager 1355, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The uplink power control parameter manager 1325 is capable of, configured to, or operable to support a means for transmitting, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The uplink scheduling manager 1330 is capable of, configured to, or operable to support a means for transmitting, to the UE, scheduling information for a first uplink transmission in a first time resource of the first subset of time resources and a second uplink transmission in a second time resource of the second subset of time resources. The uplink reception manager 1335 is capable of, configured to, or operable to support a means for receiving, from the UE, the first uplink transmission in the first time resource. In some examples, the uplink reception manager 1335 is capable of, configured to, or operable to support a means for receiving, from the UE, the second uplink transmission in the second time resource.

In some examples, the TPC manager 1340 is capable of, configured to, or operable to support a means for transmitting, to the UE, a first TPC associated with the first uplink transmission that indicates a first uplink power control adjustment value to apply to a first cumulative uplink power control adjustment value stored at the UE, where the first set of uplink power control parameters includes the first cumulative uplink power control adjustment value. In some examples, the TPC manager 1340 is capable of, configured to, or operable to support a means for transmitting, to the UE, a second TPC associated with the second uplink transmission that indicates a second uplink power control adjustment value to apply to a second cumulative uplink power control adjustment value stored at the UE, where the first set of uplink power control parameters includes the first cumulative uplink power control adjustment value.

In some examples, the UE accumulator capability manager 1350 is capable of, configured to, or operable to support a means for receiving, from the UE, capability information that indicates a capability of the UE to support two uplink power control adjustment accumulators, where transmission of the first TPC and the second TPC is based on the capability information.

In some examples, to support transmitting the indication of the second set of uplink power control parameters, the uplink scheduling manager 1330 is capable of, configured to, or operable to support a means for transmitting an indication of a respective offset for one or more parameters of the first set of uplink power control parameters.

In some examples, the first set of uplink power control parameters includes a first P0 value and a first alpha value. In some examples, the second set of uplink power control parameters includes a second P0 value and a second alpha value. In some examples, the first set of uplink power control parameters includes a first closed loop power state and the second set of uplink power control parameters includes a second closed loop power state.

In some examples, the first set of uplink power control parameters and the second set of uplink power control parameters include a same P0 value and a same first alpha value, the first set of uplink power control parameters includes a first closed loop power state, and the second set of uplink power control parameters includes a second closed loop power state.

In some examples, the TPC manager 1340 is capable of, configured to, or operable to support a means for transmitting, to the UE, a first TPC associated with the first uplink transmission that indicates a first absolute uplink power control adjustment value, where the first set of uplink power control parameters includes a first set of absolute uplink power control adjustment values and the second set of uplink power control parameters includes a second set of absolute uplink power control adjustment values, and where the first absolute uplink power control adjustment value is one of the first set of absolute uplink power control adjustment values. In some examples, the TPC manager 1340 is capable of, configured to, or operable to support a means for transmitting, to the UE, a second TPC associated with the second uplink transmission that indicates a second absolute uplink power control adjustment value, where the second absolute uplink power control adjustment value is one of the second set of absolute uplink power control adjustment values.

In some examples, the resource type manager 1345 is capable of, configured to, or operable to support a means for transmitting, with the control information, an indication that the first subset of time resources are uplink type resources and that the second subset of time resources are SBFD type uplink subband resources.

In some examples, the resource type manager 1345 is capable of, configured to, or operable to support a means for transmitting, with the control information, an indication that the first subset of time resources are uplink type TDD resources and that the second subset of time resources are full duplex type resources, where an uplink bandwidth part of the full duplex type resources at least partially overlaps with a downlink bandwidth part of the full duplex type resources.

In some examples, the uplink power control parameter manager 1325 is capable of, configured to, or operable to support a means for transmitting, with the control information, an indication to apply the first set of uplink power control parameters to the first subset of time resources and to apply the second set of uplink power control parameters to the second subset of time resources.

In some examples, the TDD manager 1355 is capable of, configured to, or operable to support a means for identifying that the first subset of time resources are misaligned with TDD resources of a second network entity and that the second subset of time resources are aligned with the TDD resources of the second network entity, where the control information is based on the identifying.

In some examples, the TDD manager 1355 is capable of, configured to, or operable to support a means for transmitting, with the control information, an indication of time division duplexing resources for a second network entity.

In some examples, to support transmitting the scheduling information, the uplink scheduling manager 1330 is capable of, configured to, or operable to support a means for transmitting a first control message that schedules the first uplink transmission. In some examples, to support transmitting the scheduling information, the uplink scheduling manager 1330 is capable of, configured to, or operable to support a means for transmitting a second control message that scheduled the second uplink transmission.

In some examples, to support transmitting the scheduling information, the uplink scheduling manager 1330 is capable of, configured to, or operable to support a means for transmitting a configured grant that schedules a set of uplink transmissions, the set of uplink transmissions including the first uplink transmission and the second uplink transmission.

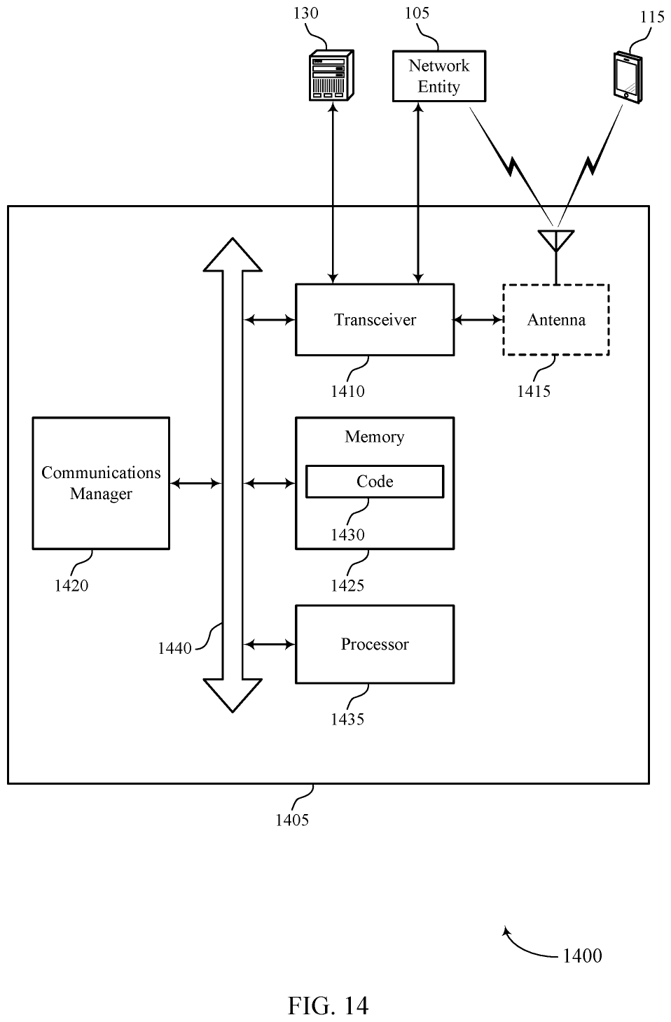

FIG. 14 shows a diagram of a system 1400 including a device 1405 that supports two sets of uplink power control parameters in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting two sets of uplink power control parameters). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The communications manager 1420 is capable of, configured to, or operable to support a means for transmitting, to the UE, scheduling information for a first uplink transmission in a first time resource of the first subset of time resources and a second uplink transmission in a second time resource of the second subset of time resources. The communications manager 1420 is capable of, configured to, or operable to support a means for receiving, from the UE, the first uplink transmission in the first time resource. The communications manager 1420 is capable of, configured to, or operable to support a means for receiving, from the UE, the second uplink transmission in the second time resource.

By including or configuring the communications manager 1420 in accordance with examples as described herein, the device 1405 may support techniques for improved communication reliability, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of two sets of uplink power control parameters as described herein, or the at least one processor 1435 and the at least one memory 1425 may be otherwise configured to, individually or collectively, perform or support such operations.

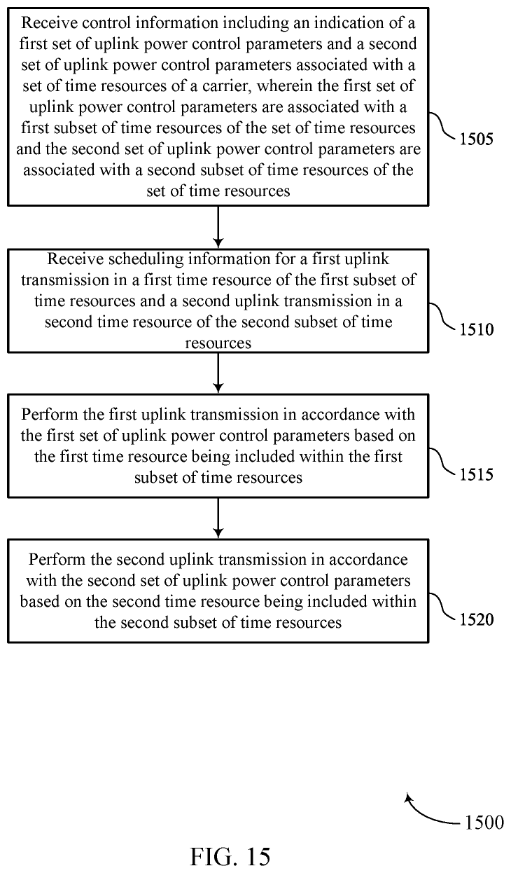

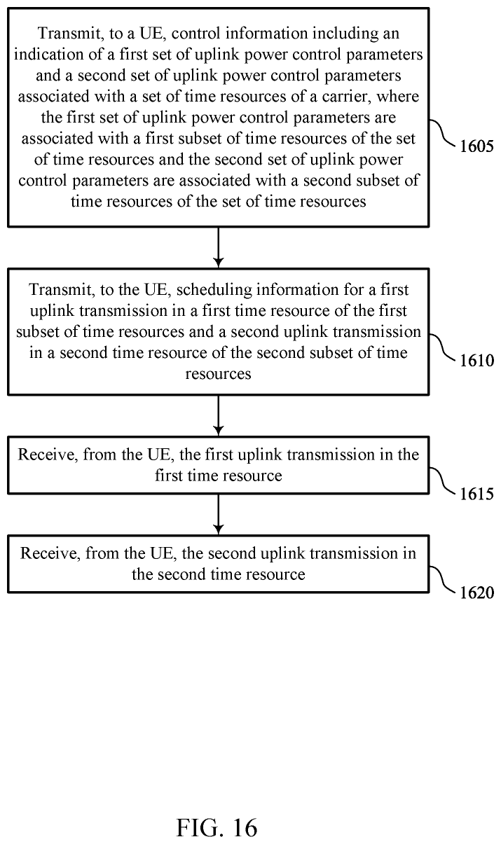

FIG. 15 shows a flowchart illustrating a method 1500 that supports two sets of uplink power control parameters in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The operations of block 1505 may be performed in accordance with examples as disclosed herein. In some examples, aspects of the operations of 1505 may be performed by an uplink power control parameter manager 925 as described with reference to FIG. 9.

At 1510, the method may include receiving scheduling information for a first uplink transmission in a first time resource of the first subset of time resources and a second uplink transmission in a second time resource of the second subset of time resources. The operations of block 1510 may be performed in accordance with examples as disclosed herein. In some examples, aspects of the operations of 1510 may be performed by an uplink scheduling manager 930 as described with reference to FIG. 9.

At 1515, the method may include performing the first uplink transmission in accordance with the first set of uplink power control parameters based on the first time resource being included within the first subset of time resources. The operations of block 1515 may be performed in accordance with examples as disclosed herein. In some examples, aspects of the operations of 1515 may be performed by an uplink transmission manager 935 as described with reference to FIG. 9.

At 1520, the method may include performing the second uplink transmission in accordance with the second set of uplink power control parameters based on the second time resource being included within the second subset of time resources. The operations of block 1520 may be performed in accordance with examples as disclosed herein. In some examples, aspects of the operations of 1520 may be performed by an uplink transmission manager 935 as described with reference to FIG. 9.

FIG. 1 shows a flowchart illustrating a method 100 that supports two sets of power control parameters in accordance with aspects of the present disclosure. The operations of the method 100 may be implemented by a network entity or its components as described herein. For example, the operations of the method 100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 105, the method may include transmitting, to a UE, control information including an indication of a first set of uplink power control parameters and a second set of uplink power control parameters associated with a set of time resources of a carrier, where the first set of uplink power control parameters are associated with a first subset of time resources of the set of time resources and the second set of uplink power control parameters are associated with a second subset of time resources of the set of time resources. The operations of block 105 may be performed in accordance with examples as disclosed herein. In some examples, aspects of the operations of 105 may be performed by an uplink power control parameter manager 1325 as described with reference to FIG. 13.

At 110, the method may include transmitting, to the UE, scheduling information for a first uplink transmission in a first time resource of the first subset of time resources and a second uplink transmission in a second time resource of the second subset of time resources. The operations of block 110 may be performed in accordance with examples as disclosed herein. In some examples, aspects of the operations of 110 may be performed by an uplink scheduling manager 1330 as described with reference to FIG. 13.

At 115, the method may include receiving, from the UE, the first uplink transmission in the first time resource. The operations of block 115 may be performed in accordance with examples as disclosed herein. In some examples, aspects of the operations of 115 may be performed by an uplink reception manager 1335 as described with reference to FIG. 13.

At 120, the method may include receiving, from the UE, the second uplink transmission in the second time resource. The operations of block 120 may be performed in accordance with examples as disclosed herein. In some examples, aspects of the operations of 120 may be performed by an uplink reception manager 1335 as described with reference to FIG. 13.

The following provides an overview of aspects of the present disclosure:

Aspect 1: A method for wireless communications at a UE, comprising: receiving control information including an indication of a first set of uplink power control parameters and a second set of uplink power control parameters associated with a set of time resources of a carrier, wherein the first set of uplink power control parameters are associated with a first subset of time resources of the set of time resources and the second set of uplink power control parameters are associated with a second subset of time resources of the set of time resources; receiving scheduling information for a first uplink transmission in a first time resource of the first subset of time resources and a second uplink transmission in a second time resource of the second subset of time resources; performing the first uplink transmission in accordance with the first set of uplink power control parameters based at least in part on the first time resource being included within the first subset of time resources; and performing the second uplink transmission in accordance with the second set of uplink power control parameters based at least in part on the second time resource being included within the second subset of time resources.

Aspect 2: The method of aspect 1, further comprising: receiving a first TPC associated with the first uplink transmission that indicates a first uplink power control adjustment value to apply to a first cumulative uplink power control adjustment value stored at the UE, wherein the first set of uplink power control parameters comprises the first cumulative uplink power control adjustment value; and receiving a second TPC associated with the second uplink transmission that indicates a second uplink power control adjustment value to apply to a second cumulative uplink power control adjustment value stored at the UE, wherein the first set of uplink power control parameters comprises the first cumulative uplink power control adjustment value.

Aspect 3: The method of aspect 2, further comprising: transmitting capability information that indicates a capability of the UE to support two uplink power control adjustment accumulators, wherein reception of the first TPC and the second TPC is based at least in part on the capability information.

Aspect 4: The method of any of aspects 1 through 3, wherein receiving the indication of the second set of uplink power control parameters comprises: receiving an indication of a respective offset for one or more parameters of the first set of uplink power control parameters.

Aspect 5: The method of any of aspects 1 through 4, wherein the first set of uplink power control parameters comprises a first P0 value and a first alpha value, and the second set of uplink power control parameters comprises a second P0 value and a second alpha value.

Aspect 6: The method of aspect 5, wherein the first set of uplink power control parameters comprises a first closed loop power state, and the second set of uplink power control parameters comprises a second closed loop power state.

Aspect 7: The method of any of aspects 1 through 6, wherein the first set of uplink power control parameters and the second set of uplink power control parameters are associated with a same configured P0 value and a same configured first alpha value, the first set of uplink power control parameters comprises a first closed loop power state, and the second set of uplink power control parameters comprises a second closed loop power state.

Aspect 8: The method of any of aspects 4 through 7, further comprising: receiving a first TPC associated with the first uplink transmission that indicates a first absolute uplink power control adjustment value, wherein the first set of uplink power control parameters includes a first set of absolute uplink power control adjustment values and the second set of uplink power control parameters includes a second set of absolute uplink power control adjustment values, and wherein the first absolute uplink power control adjustment value is one of the first set of absolute uplink power control adjustment values; and receiving a second TPC associated with the second uplink transmission that indicates a second absolute uplink power control adjustment value, wherein the second absolute uplink power control adjustment value is one of the second set of absolute uplink power control adjustment values.

Aspect 9: The method of any of aspects 1 through 8, further comprising: receiving, with the control information, an indication that the first subset of time resources are uplink type resources and that the second subset of time resources are SBFD type uplink subband resources, wherein the first time resource is an uplink type resource, and wherein the second time resource is a SBFD type uplink subband resource.

Aspect 10: The method of any of aspects 1 through 8, further comprising: receiving, with the control information, an indication that the first subset of time resources are uplink type TDD resources and that the second subset of time resources are full duplex type resources, wherein an uplink BWP of the full duplex type resources at least partially overlaps with a downlink BWP of the full duplex type resources, wherein the first time resource is an uplink type TDD resource, and wherein the second time resource is a full duplex type resource.

Aspect 11: The method of any of aspects 1 through 8, further comprising: receiving, with the control information, an indication of TDD resources for a second network entity, wherein the UE is associated with a first network entity, wherein the first set of time resources are misaligned with the TDD resources of the second network entity and the second set of time resources are aligned with the TDD resources of the second network entity.

Aspect 12: The method of any of aspects 1 through 8, further comprising: receiving, with the control information, an indication to apply the first set of uplink power control parameters to the first subset of time resources and to apply the second set of uplink power control parameters to the second subset of time resources.

Aspect 13: The method of any of aspects 1 through 12, wherein receiving the scheduling information comprises: receiving a first control message that schedules the first uplink transmission; and receiving a second control message that scheduled the second uplink transmission.

Aspect 14: The method of any of aspects 1 through 12, wherein receiving the scheduling information comprises: receiving a configured grant that schedules a set of uplink transmissions, the set of uplink transmissions comprising the first uplink transmission and the second uplink transmission.

Aspect 15: A method for wireless communications at a network entity, comprising: transmitting, to a UE, control information including an indication of a first set of uplink power control parameters and a second set of uplink power control parameters associated with a set of time resources of a carrier, wherein the first set of uplink power control parameters are associated with a first subset of time resources of the set of time resources and the second set of uplink power control parameters are associated with a second subset of time resources of the set of time resources; transmitting, to the UE, scheduling information for a first uplink transmission in a first time resource of the first subset of time resources and a second uplink transmission in a second time resource of the second subset of time resources; receiving, from the UE, the first uplink transmission in the first time resource; and receiving, from the UE, the second uplink transmission in the second time resource.

Aspect 16: The method of aspect 15, further comprising: transmitting, to the UE, a first TPC associated with the first uplink transmission that indicates a first uplink power control adjustment value to apply to a first cumulative uplink power control adjustment value stored at the UE, wherein the first set of uplink power control parameters comprises the first cumulative uplink power control adjustment value; and transmitting, to the UE, a second TPC associated with the second uplink transmission that indicates a second uplink power control adjustment value to apply to a second cumulative uplink power control adjustment value stored at the UE, wherein the first set of uplink power control parameters comprises the first cumulative uplink power control adjustment value.

Aspect 17: The method of aspect 16, further comprising: receiving, from the UE, capability information that indicates a capability of the UE to support two uplink power control adjustment accumulators, wherein transmission of the first TPC and the second TPC is based at least in part on the capability information.

Aspect 18: The method of any of aspects 15 through 17, wherein transmitting the indication of the second set of uplink power control parameters comprises: transmitting an indication of a respective offset for one or more parameters of the first set of uplink power control parameters.

Aspect 19: The method of any of aspects 15 through 18, wherein the first set of uplink power control parameters comprises a first P0 value and a first alpha value, and the second set of uplink power control parameters comprises a second P0 value and a second alpha value.

Aspect 20: The method of aspect 19, wherein the first set of uplink power control parameters comprises a first closed loop power state, and the second set of uplink power control parameters comprises a second closed loop power state.

Aspect 21: The method of any of aspects 15 through 20, wherein the first set of uplink power control parameters and the second set of uplink power control parameters comprise a same P0 value and a same first alpha value, the first set of uplink power control parameters comprises a first closed loop power state, and the second set of uplink power control parameters comprises a second closed loop power state.

Aspect 22: The method of any of aspects 18 through 21, further comprising: transmitting, to the UE, a first TPC associated with the first uplink transmission that indicates a first absolute uplink power control adjustment value, wherein the first set of uplink power control parameters includes a first set of absolute uplink power control adjustment values and the second set of uplink power control parameters includes a second set of absolute uplink power control adjustment values, and wherein the first absolute uplink power control adjustment value is one of the first set of absolute uplink power control adjustment values; and transmitting, to the UE, a second TPC associated with the second uplink transmission that indicates a second absolute uplink power control adjustment value, wherein the second absolute uplink power control adjustment value is one of the second set of absolute uplink power control adjustment values.

Aspect 23: The method of any of aspects 15 through 22, further comprising: transmitting, with the control information, an indication that the first subset of time resources are uplink type resources and that the second subset of time resources are SBFD type uplink subband resources.

Aspect 24: The method of any of aspects 15 through 22, further comprising: transmitting, with the control information, an indication that the first subset of time resources are uplink type TDD resources and that the second subset of time resources are full duplex type resources, wherein an uplink BWP of the full duplex type resources at least partially overlaps with a downlink BWP of the full duplex type resources.

Aspect 25: The method of any of aspects 15 through 22, further comprising: transmitting, with the control information, an indication to apply the first set of uplink power control parameters to the first subset of time resources and to apply the second set of uplink power control parameters to the second subset of time resources.

Aspect 26: The method of aspect 25, further comprising: identifying that the first subset of time resources are misaligned with TDD resources of a second network entity and that the second subset of time resources are aligned with the TDD resources of the second network entity, wherein the control information is based at least in part on the identifying.

Aspect 27: The method of any of aspects 15 through 22, further comprising: transmitting, with the control information, an indication of TDD resources for a second network entity.

Aspect 28: The method of any of aspects 15 through 27, wherein transmitting the scheduling information comprises: transmitting a first control message that schedules the first uplink transmission; and transmitting a second control message that scheduled the second uplink transmission.

Aspect 29: The method of any of aspects 15 through 27, wherein transmitting the scheduling information comprises: transmitting a configured grant that schedules a set of uplink transmissions, the set of uplink transmissions comprising the first uplink transmission and the second uplink transmission.

Aspect 30: A UE for wireless communications, comprising one or more memories storing processor-executable code, and one or more processors coupled with the one or more memories and individually or collectively operable to execute the code to cause the UE to perform a method of any of aspects 1 through 14.

Aspect 31: A UE for wireless communications, comprising at least one means for performing a method of any of aspects 1 through 14.

Aspect 32: A non-transitory computer-readable medium storing code for wireless communications, the code comprising instructions executable by a processor to perform a method of any of aspects 1 through 14.

Aspect 33: A network entity for wireless communications, comprising one or more memories storing processor-executable code, and one or more processors coupled with the one or more memories and individually or collectively operable to execute the code to cause the network entity to perform a method of any of aspects 15 through 29.

Aspect 34: A network entity for wireless communications, comprising at least one means for performing a method of any of aspects 15 through 29.

Aspect 35: A non-transitory computer-readable medium storing code for wireless communications, the code comprising instructions executable by a processor to perform a method of any of aspects 15 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information including an indication of a first set of uplink power control parameters and a second set of uplink power control parameters associated with a set of time resources of a carrier, wherein the first set of uplink power control parameters are associated with a first subset of time resources of the set of time resources and the second set of uplink power control parameters are associated with a second subset of time resources of the set of time resources;
receive scheduling information for a first uplink transmission in a first time resource of the first subset of time resources and a second uplink transmission in a second time resource of the second subset of time resources;
perform the first uplink transmission in accordance with the first set of uplink power control parameters based at least in part on the first time resource being included within the first subset of time resources; and
perform the second uplink transmission in accordance with the second set of uplink power control parameters based at least in part on the second time resource being included within the second subset of time resources.

2. The UE of claim 1, wherein the one or more processors are individually or collectively further operable to execute the code to cause the UE to:
receive a first transmit power command associated with the first uplink transmission that indicates a first uplink power control adjustment value to apply to a first cumulative uplink power control adjustment value stored at the UE, wherein the first set of uplink power control parameters comprises the first cumulative uplink power control adjustment value; and
receive a second transmit power command associated with the second uplink transmission that indicates a second uplink power control adjustment value to apply to a second cumulative uplink power control adjustment value stored at the UE, wherein the first set of uplink power control parameters comprises the first cumulative uplink power control adjustment value.

3. The UE of claim 2, wherein the one or more processors are individually or collectively further operable to execute the code to cause the UE to:
transmit capability information that indicates a capability of the UE to support two uplink power control adjustment accumulators, wherein reception of the first transmit power command and the second transmit power command is based at least in part on the capability information.

4. The UE of claim 1, wherein, to receive the indication of the second set of uplink power control parameters, the one or more processors are individually or collectively operable to execute the code to cause the UE to:
receive an indication of a respective offset for one or more parameters of the first set of uplink power control parameters.

5. The UE of claim 1, wherein:
the first set of uplink power control parameters comprises a first P0 value and a first alpha value, and
the second set of uplink power control parameters comprises a second P0 value and a second alpha value.

6. The UE of claim 5, wherein:
the first set of uplink power control parameters comprises a first closed loop power state; and
the second set of uplink power control parameters comprises a second closed loop power state.

7. The UE of claim 1, wherein the first set of uplink power control parameters and the second set of uplink power control parameters are associated with a same configured P0 value and a same configured first alpha value, wherein the first set of uplink power control parameters comprises a first closed loop power state, and wherein the second set of uplink power control parameters comprises a second closed loop power state.

8. The UE of claim 1, wherein the one or more processors are individually or collectively further operable to execute the code to cause the UE to:
receive a first transmit power command associated with the first uplink transmission that indicates a first absolute uplink power control adjustment value, wherein the first set of uplink power control parameters includes a first set of absolute uplink power control adjustment values and the second set of uplink power control parameters includes a second set of absolute uplink power control adjustment values, and wherein the first absolute uplink power control adjustment value is one of the first set of absolute uplink power control adjustment values; and
receive a second transmit power command associated with the second uplink transmission that indicates a second absolute uplink power control adjustment value, wherein the second absolute uplink power control adjustment value is one of the second set of absolute uplink power control adjustment values.

9. The UE of claim 1, wherein the one or more processors are individually or collectively further operable to execute the code to cause the UE to:
receive, with the control information, an indication that the first subset of time resources are uplink type resources and that the second subset of time resources are subband full duplex type uplink subband resources, wherein the first time resource is an uplink type resource, and wherein the second time resource is a subband full duplex type uplink subband resource.

10. The UE of claim 1, wherein the one or more processors are individually or collectively further operable to execute the code to cause the UE to:
receive, with the control information, an indication that the first subset of time resources are uplink type time division duplexing resources and that the second subset of time resources are full duplex type resources, wherein an uplink bandwidth part of the full duplex type resources at least partially overlaps with a downlink bandwidth part of the full duplex type resources, wherein the first time resource is an uplink type time division duplexing resource, and wherein the second time resource is a full duplex type resource.

11. The UE of claim 1, wherein the one or more processors are individually or collectively further operable to execute the code to cause the UE to:
receive, with the control information, an indication of time division duplexing resources for a second network entity, wherein the UE is associated with a first network entity, wherein the first subset of time resources are misaligned with the time division duplexing resources of the second network entity and the second subset of time resources are aligned with the time division duplexing resources of the second network entity.

12. The UE of claim 1, wherein the one or more processors are individually or collectively further operable to execute the code to cause the UE to:
receive, with the control information, an indication to apply the first set of uplink power control parameters to the first subset of time resources and to apply the second set of uplink power control parameters to the second subset of time resources.

13. The UE of claim 1, wherein, to receive the scheduling information, the one or more processors are individually or collectively operable to execute the code to cause the UE to:
receive a first control message that schedules the first uplink transmission; and
receive a second control message that scheduled the second uplink transmission.

14. The UE of claim 1, wherein, to receive the scheduling information, the one or more processors are individually or collectively operable to execute the code to cause the UE to:
receive a configured grant that schedules a set of uplink transmissions, the set of uplink transmissions comprising the first uplink transmission and the second uplink transmission.

15. A network entity, comprising:
one or more memories storing processor-executable code; and
one or more processors coupled with the one or more memories and individually or collectively operable to execute the code to cause the network entity to:
transmit, to a user equipment (UE), control information including an indication of a first set of uplink power control parameters and a second set of uplink power control parameters associated with a set of time resources of a carrier, wherein the first set of uplink power control parameters are associated with a first subset of time resources of the set of time resources and the second set of uplink power control parameters are associated with a second subset of time resources of the set of time resources;
transmit, to the UE, scheduling information for a first uplink transmission in a first time resource of the first subset of time resources and a second uplink transmission in a second time resource of the second subset of time resources;
receive, from the UE, the first uplink transmission in the first time resource; and
receive, from the UE, the second uplink transmission in the second time resource.

16. The network entity of claim 15, wherein the one or more processors are individually or collectively further operable to execute the code to cause the network entity to:
transmit, to the UE, a first transmit power command associated with the first uplink transmission that indicates a first uplink power control adjustment value to apply to a first cumulative uplink power control adjustment value stored at the UE, wherein the first set of uplink power control parameters comprises the first cumulative uplink power control adjustment value; and
transmit, to the UE, a second transmit power command associated with the second uplink transmission that indicates a second uplink power control adjustment value to apply to a second cumulative uplink power control adjustment value stored at the UE, wherein the first set of uplink power control parameters comprises the first cumulative uplink power control adjustment value.

17. The network entity of claim 16, wherein the one or more processors are individually or collectively further operable to execute the code to cause the network entity to:
receive, from the UE, capability information that indicates a capability of the UE to support two uplink power control adjustment accumulators, wherein transmission of the first transmit power command and the second transmit power command is based at least in part on the capability information.

18. The network entity of claim 15, wherein, to transmit the indication of the second set of uplink power control parameters, the one or more processors are individually or collectively operable to execute the code to cause the network entity to:
transmit an indication of a respective offset for one or more parameters of the first set of uplink power control parameters.

19. The network entity of claim 15, wherein:
the first set of uplink power control parameters comprises a first P0 value and a first alpha value, and
the second set of uplink power control parameters comprises a second P0 value and a second alpha value.

20. The network entity of claim 19, wherein:
the first set of uplink power control parameters comprises a first closed loop power state; and
the second set of uplink power control parameters comprises a second closed loop power state.

21. The network entity of claim 15, wherein the first set of uplink power control parameters and the second set of uplink power control parameters comprise a same P0 value and a same first alpha value, wherein the first set of uplink power control parameters comprises a first closed loop power state, and wherein the second set of uplink power control parameters comprises a second closed loop power state.

22. The network entity of claim 15, wherein the one or more processors are individually or collectively further operable to execute the code to cause the network entity to:
transmit, to the UE, a first transmit power command associated with the first uplink transmission that indicates a first absolute uplink power control adjustment value, wherein the first set of uplink power control parameters includes a first set of absolute uplink power control adjustment values and the second set of uplink power control parameters includes a second set of absolute uplink power control adjustment values, and wherein the first absolute uplink power control adjustment value is one of the first set of absolute uplink power control adjustment values; and
transmit, to the UE, a second transmit power command associated with the second uplink transmission that indicates a second absolute uplink power control adjustment value, wherein the second absolute uplink power control adjustment value is one of the second set of absolute uplink power control adjustment values.

23. The network entity of claim 15, wherein the one or more processors are individually or collectively further operable to execute the code to cause the network entity to:
transmit, with the control information, an indication that the first subset of time resources are uplink type resources and that the second subset of time resources are subband full duplex type uplink subband resources.

24. The network entity of claim 15, wherein the one or more processors are individually or collectively further operable to execute the code to cause the network entity to:
transmit, with the control information, an indication that the first subset of time resources are uplink type time division duplexing resources and that the second subset of time resources are full duplex type resources, wherein an uplink bandwidth part of the full duplex type resources at least partially overlaps with a downlink bandwidth part of the full duplex type resources.

25. The network entity of claim 15, wherein the one or more processors are individually or collectively further operable to execute the code to cause the network entity to:
transmit, with the control information, an indication to apply the first set of uplink power control parameters to the first subset of time resources and to apply the second set of uplink power control parameters to the second subset of time resources.

26. The network entity of claim 25, wherein the one or more processors are individually or collectively further operable to execute the code to cause the network entity to:
identify that the first subset of time resources are misaligned with time division duplexing resources of a second network entity and that the second subset of time resources are aligned with the time division duplexing resources of the second network entity, wherein the control information is based at least in part on the identifying.

27. The network entity of claim 15, wherein the one or more processors are individually or collectively further operable to execute the code to cause the network entity to:
transmit, with the control information, an indication of time division duplexing resources for a second network entity.

28. The network entity of claim 15, wherein, to transmit the scheduling information, the one or more processors are individually or collectively operable to execute the code to cause the network entity to:
transmit a first control message that schedules the first uplink transmission; and
transmit a second control message that scheduled the second uplink transmission.

29. A method for wireless communications at a user equipment (UE), comprising:
receiving control information including an indication of a first set of uplink power control parameters and a second set of uplink power control parameters associated with a set of time resources of a carrier, wherein the first set of uplink power control parameters are associated with a first subset of time resources of the set of time resources and the second set of uplink power control parameters are associated with a second subset of time resources of the set of time resources;
receiving scheduling information for a first uplink transmission in a first time resource of the first subset of time resources and a second uplink transmission in a second time resource of the second subset of time resources;
performing the first uplink transmission in accordance with the first set of uplink power control parameters based at least in part on the first time resource being included within the first subset of time resources; and
performing the second uplink transmission in accordance with the second set of uplink power control parameters based at least in part on the second time resource being included within the second subset of time resources.

30. A method for wireless communications at a network entity, comprising:
transmitting, to a user equipment (UE), control information including an indication of a first set of uplink power control parameters and a second set of uplink power control parameters associated with a set of time resources of a carrier, wherein the first set of uplink power control parameters are associated with a first subset of time resources of the set of time resources and a second subset of uplink power control parameters are associated with a second subset of time resources of the set of time resources;
transmitting, to the UE, scheduling information for a first uplink transmission in a first time resource of the first subset of time resources and a second uplink transmission in a second time resource of the second subset of time resources;
receiving, from the UE, the first uplink transmission in the first time resource; and
receiving, from the UE, the second uplink transmission in the second time resource.
